(19) United States
(12) Patent Application Publication
(10) Pub. No.: US 2006/0061913 A1
(43) Pub. Date: Mar. 23, 2006

(54) Magnetic read/write system, magnetoresistive head, and magnetic recording medium

(75) Inventors: Noboru Sekiguchi, Miyagi (JP); Shinji Kudo, Miyagi (JP); Kanako Toba, Miyagi (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(73) Assignee: Sony Corporation

(21) Appl. No.: 11/228,634

(22) Filed: Sep. 16, 2005

(30) Foreign Application Priority Data
Sep. 21, 2004 (JP) P2004-274231

(51) Int. Cl. G11B 5/127; G11B 5/33

(52) U.S. Cl. 360/323

(57) ABSTRACT

A magnetic read/write system includes a magnetic read/write apparatus containing a magnetoresistive head having at least one flux guide; and a magnetic recording medium including a magnetic layer on a nonmagnetic support; the magnetoresistive head including a static charge-removing unit for removing static charges, the thickness of the magnetic layer constituting the magnetic recording medium being 0.3 μm or less, and the surface electric resistivity of the surface of the magnetic layer being in the range of 1×10⁸ to 1×10¹³ Ω/sq.

### CROSS REFERENCE TO RELATED APPLICATIONS

The present invention contains subject matter related to Japanese Patent Application JP 2004-274231 filed in the Japanese Patent Office on Sep. 21, 2004, the entire contents of which being incorporated herein by reference.

### BACKGROUND OF THE INVENTION

### Field of the Invention

The present invention relates to a magnetic read/write system achieving a good balance between high electromagnetic conversion characteristics and satisfactory system stability, a magnetoresistive head, and a magnetic recording medium, the magnetoresistive head and the magnetic recording medium constituting the magnetic read/write system.

In recent years, an increase in the amount of information in a recording medium with developments of digital recording or the like may require trends toward higher recording density and shorter wavelength recording.

In magnetic recording media applied to magnetic read/write systems, in order to achieve shorter wavelength output and to improve C/N characteristics, magnetic characteristics have been improved. Furthermore, in order to reduce spacing loss and modulation noise, the thickness of the magnetic layer has been reduced, and the surface of the magnetic layer has been smoothed. Consequently, a magnetic recording medium having thin magnetic layer has been developed and commercialized.

In order to correspond to further shorter wavelength recording, a read/write system including a magnetoresistive head (MR head), which is higher sensitivity than that of an inductive read head, will be mainly used in the future.

However, in applying a highly sensitive magnetic head, such as the magnetoresistive head, a problem with the electrostatic destruction (ESD) of the MR element become evident. In a general inductive read head, such a problem did not occur.

Sliding a magnetic recording medium and a magnetic head generates static charges (static electricity). In removing the static charges from the magnetic head, the static charges pass through the head, thereby generating Joule heat, which causes the destruction of the element. Furthermore, this may also destruct the magnetic read/write system including the magnetic head.

To prevent such an electrostatic destruction of the element, traditionally, various technical approaches have been proposed.

An example of the approach is a structure in which the MR element is not exposed to a sliding surface that is brought into contact with a magnetic head but provided inside the head. This structure can effectively prevent the electrostatic destruction of the element, a change in characteristic due to the wear of the element, and a reduction in reliability due to sliding noise.

In a structure in which an MR element is disposed inside a head, for example, Japanese Unexamined Patent Application Publication No. 10-222819 disclosed a method for introducing signal flux from a magnetic recording medium, the method including disposing a flux guide formed of a soft magnetic thin film adjacent to the magnetic recording medium, an end of the flux guide being exposed to a surface facing the magnetic recording medium. Magnetic flux generated from a magnetic pattern recorded on the magnetic recording medium was introduced to the MR element through the flux guide.

A typical flux guide MR head will be described with reference to the drawings.

A flux guide MR head 10 as shown in FIG. 49 includes a bottom magnetic shield layer 15, a top magnetic shield layer 28, gap films 18a to 18c, an MR element 22, and flux guide 20, the MR element 22 and the flux guide 20 being disposed between the shield layers.

The flux guide 20 is disposed adjacent to a medium-facing surface α1 in a manner such that an end of the flux guide 20 is exposed to the exterior at the medium-facing surface α1. The MR element 22 is disposed remote from the flux guide 20 in a manner such that the MR element 22 is not exposed to the exterior at the medium-facing surface α1.

In this flux guide MR head 10, a signal magnetic field is transmitted from the magnetic recording medium to the MR element 22 through the flux guide 20.

The resistance of the MR element 22 is changed in response to the signal magnetic field transmitted to the MR element 22, and the change in the resistance of the MR element 22 is detected as a change in voltage. In this way, a magnetic signal written on the magnetic recording medium is read out.

In the flux guide MR head 10 having the structure described above, the MR element 22 is not exposed to the exterior at the medium-facing surface α1. This structure significantly reduce the possibility of the destruction of the MR element 22 due to the flow of static charges generated by sliding the medium-facing surface α1 into the MR element 22 even when the flux guide MR head 10 is used as a read head for a read/write system in which the head is brought into contact with the magnetic recording medium like a read/write system using a tape.

Furthermore, it is possible to appropriately read a magnetic signal without a disadvantageous change in characteristic due to wearing and an undesirable reduction in reliability due to sliding noise.

The structure of the flux guide MR head 10 will be described below.

For example, a soft magnetic film composed of, for example, an Ni—Fe-based alloy (permalloy) or an Fe—Si—Al-based alloy (sendust) and having a thickness of, for example, 3 μm is formed on a first substrate 11 via a nonmagnetic, nonconductive underlying layer 14 and then processed into a predetermined shape to form the bottom magnetic shield layer 15.

The bottom magnetic shield layer 15 and the top magnetic shield layer 28 have a function of shielding a disturbing magnetic field other than a signal magnetic field.

For example, a nonmagnetic, nonconductive film composed of Al₂O₃ or the like is formed on the bottom magnetic shield layer 15 to form the gap between the shields 18. In an flux guide MR head according to an embodiment of the present invention, the gap between the shields 18 includes first gap film 18a on the bottom magnetic shield layer 15, a second gap film 18b on the first gap film 18a, and a third gap film 18c on the second gap film 18b.

In an example of the MR element, the flux guide 20 is provided on the first gap film 18a and covered with the second gap film 18b, and the MR element 22 is provided on the second gap film 18b and covered with the third gap film 18c.

The flux guide 20 is provided for absorbing a signal magnetic field from a magnetic tape and then efficiently introducing the absorbed signal magnetic field to the MR element 22. For example, a soft magnetic film composed of an Ni—Fe-based alloy or the like is formed on the first gap film 18a, which will constitute the gap between shields 18, and processed into a predetermined shape such that an end of the soft magnetic film is exposed to the exterior at the medium-facing surface α1, thereby forming the flux guide 20.

This flux guide 20 is preferably disposed at the middle position in the gap between shields 18 in a manner such that the distance between the flux guide 20 and the bottom magnetic shield layer 15 is identical to the distance between the flux guide 20 and the top magnetic shield layer 28.

That is, in this MR head, the thickness of the first gap film 18a disposed below the flux guide 20 is preferably identical to the sum of the thicknesses of the second gap films 18b and 18c, which are disposed on the flux guide 20.

In the flux guide 20, magnetic anisotropy is preferably controlled in a manner such that the easy magnetization axis is parallel to the medium-facing surface α1.

The magnetic anisotropy of the flux guide 20 can be controlled by the following process: for example, a process of forming a soft magnetic film, composed of an Ni—Fe-based alloy or the like, to be flux guide 20 by sputtering in a magnetic field; or a process of forming a soft magnetic film, composed of an Ni—Fe-based alloy or the like, to be flux guide 20 and then subjecting the resulting soft magnetic film to static field anneal (SFA).

As described above, controlling the magnetic anisotropy of the flux guide 20 results in an increase in dynamic range for a signal magnetic field in the flux guide 20.

Alternatively, the flux guide 20 may be electrically connected to the bottom magnetic shield layer 15 and the top magnetic shield layer 28.

In this case, the flux guide 20, bottom magnetic shield layer 15, and top magnetic shield layer 28 are equipotential, thus preventing an electrical short circuit. As a result, a magnetic signal can be appropriately read.

In the MR head, as described above, the flux guide 20 is exposed at the medium-facing surface α1, and a signal magnetic field is absorbed with the flux guide 20. Therefore, the track width is determined by the width of the flux guide 20.

Two bias layers for applying a bias magnetic field are provided at the ends of the flux guide 20 in the width direction, respectively.

For example, a ferromagnetic film composed of a CoCrPt alloy or the like is formed on the first gap film 18a, which will constitute the gap between shields 18, and processed into a predetermined shape to form the bias layers.

The bias layers are provided at the ends of the flux guide 20 in the width direction and apply a bias magnetic field, thus stabilizing magnetic domains.

The thin bias layers are composed of a CoCrPt alloy or the like and polarized in producing the MR head.

Consequently, the bias layers functions to apply a bias magnetic field to the flux guide 20.

The resistance of the MR element 22 is changed in response to the change of an external magnetic field. As described above, the MR element 22 is disposed above the flux guide 20. TO be more specific, the MR element 22 is disposed on the second gap film 18b, which constitutes the gap between shields 18.

For example, the MR element 22 is preferably disposed in a manner such that the portion, adjacent to the medium-facing surface α1, of the MR element 22 overlaps with a portion, remote from the medium-facing surface α1, of the flux guide 20 with a predetermined amount of overlap via the second gap film 18b (electrically insulating film), which constitutes the gap between shields 18.

That is, in the MR head, the portion, adjacent to the medium-facing surface α1, of the MR element 22 preferably overlaps with the portion, remote from the medium-facing surface α1, of the flux guide 20 in the stacking direction via the second gap film 18b.

As the MR element 22, for example, a spin-valve giant magnetoresistive (GMR) element, which exhibits a giant magnetoresistive effect, may be used.

The spin-valve GMR element (MR element 22) (not shown) may include, for example, an antiferromagnetic layer composed of a Pt—Mn alloy or the like, a pinned magnetic layer (pinned layer) composed of an Ni—Fe-based alloy, a Co-based alloy, a Co—Fe-based alloy, a Co—Ni-based alloy, an Ni—Fe—Co-based alloy, or the like, a nonmagnetic conductive layer composed of Cu or the like, and a free magnetic layer (free layer) composed of an Ni—Fe-based alloy, a Co-based alloy, a Co—Fe-based alloy, a Co—Ni-based alloy, an Ni—Fe—Co-based alloy, or the like, these layers being stacked. The magnetization direction of the pinned layer is fixed by a bias field from the antiferromagnetic layer. The magnetization direction of the free layer is rotated in response to a signal magnetic field.

When such a spin-valve GMR element is used as an MR element in an MR head, the layers constituting the GMR element are stacked in a manner such that the free layer is disposed at the closest position to the flux guide.

A pair of bias layers also serving as electrodes is provided at the ends of the MR element in the width direction. The bias (electrode) layers apply a bias magnetic field to the free layer in the MR element 22 to put the free layer into a single-magnetic domain state, thereby suppressing Barkhausen noise. In addition, the bias (electrode) layers supply the MR element 22 with sense current.

For example, a laminate film composed of CoCrPt/TiW/Ta or the like is formed in a manner such that an end of each bias layer is magnetically and electrically connected to an end of the MR element 22, and then processed into a predetermined shape to form the bias (electrode) layers.

External terminals composed of a conductive material are provided on the other ends of the bias (electrode) layers, respectively.

IN the bias (electrode) layers, the layer composed of CoCrPt is polarized to a predetermined direction in producing the MR head. As a result, the layer functions as a permanent magnet layer, thereby applying a bias magnetic field to the MR element.

The bias (electrode) layers preferably apply a bias magnetic field to the MR element 22 in the track width direction. As a result, the free layer in the MR element 22 is magnetized in the track width direction when no signal magnetic field from the exterior is applied. Therefore, in the MR element 22, the magnetization direction of the pinned layer is perpendicular to the magnetization direction of the free layer when no signal magnetic field from the exterior is applied. As a result, the magnetoresistive effect can be maximized to a signal magnetic field.

In the MR head, the direction of a bias magnetic field applied to the flux guide by the bias layers is preferably identical to the direction of a bias magnetic field applied to the MR element by the bias (electrode) layers. As a result, a bias magnetic field is applied to the flux guide 20 in the same direction as that of a bias magnetic field applied to the free layer in the MR element 22. Therefore, the flux guide 20 can introduce a signal magnetic field to the 322 with the utmost efficiency.

The MR head is supported by a supporting unit. The external terminals are electrically connected to terminals provided on the supporting unit by wire bonding, thereby connecting to a circuit of a read/write system.

The circuit of the read/write system supplies sense current to the MR element 22 through the external terminals and the bias (electrode) layers. Then, a change in the resistance of the MR element 22 in response to a signal magnetic field is detected as a change in voltage.

For example, a soft magnetic film composed of an amorphous Ni—Fe-based alloy, an amorphous ZrNbTa alloy, an Fe—Si—Al-based alloy, or the like and having a thickness of, for example, about 3 μm is formed on the planarized surface of the third gap film 18c, which constitutes the gap between shields 18, and processed into a predetermined shape to form the top magnetic shield layer 28.

The top magnetic shield layer 28 and the bottom magnetic shield layer 15 have the function of shielding a disturbing magnetic field other than a signal magnetic field.

A second substrate (not shown) is bonded on the top magnetic shield layer 28 to complete a specialized flux guide MR head for reading.

The flux guide MR head having such a structure is generally used for a helical-scan magnetic read/write system in which writing and reading are performed by different head chips.

The flux guide MR head according to an embodiment of the present invention includes such a head chip using flux guide MR head and a head a called head block.

A write head used for magnetic writing may be provided on the top magnetic shield layer 28.

The flux guide MR head shown in FIG. 49 has such a structure.

A gap film between shields (fourth gap film) 30 composed of Al₂O₃ or the like is formed on the top magnetic shield layer 28. An upper magnetic core 35 composed of an amorphous Ni—Fe-based alloy, an amorphous ZrNbTa alloy, an Fe—Si—Al-based alloy, or the like is formed on the fourth gap film 30. The upper magnetic core 35 is magnetically connected to the top magnetic shield layer 28, thereby forming a magnetic path through the upper magnetic core 35 and the top magnetic shield layer 28.

A one-turn coil, a coil of a plurality of turns, or a coil group in which a plurality of one-turn coils are provided at a position such that interlinkage magnetic flux constituted from the upper magnetic core 35 and the top magnetic shield layer 28 pass through the coil. For example, either a first coil 33 or a second coil 34, or both, may be formed.

In order to ensure insulation between the coils, an insulating layer 112 is formed by heat-treating a photoresist pattern.

Such a magnetoresistive read head in combination with the magnetic write head is generally used for a linear-scan magnetic read/write system.

The flux guide MR head according to an embodiment of the present invention includes such a head chip using flux guide MR head and a head a called head block.

### SUMMARY OF THE INVENTION

However, in such a flux guide MR head, read efficiency may be degraded compared with that in a shield MR head, in which a MR element is exposed to a sliding surface that is brought into contact with a magnetic recording medium.

To compensate the degradation in read efficiency, a highly sensitive giant magnetoresistive (GMR) element, such as a spin-valve element, is generally used instead of the MR head. The GMR element easily undergoes electrostatic destruction compared with the MR element. Therefore, when the GMR element is applied to the flux guide MR head, it is important to prevent electrostatic destruction.

Traditionally, to prevent electrostatic destruction, a magnetic recording medium was used as a static charge-removing path to remove static charges (static electricity).

That is, the electric resistivity of a magnetic layer, a nonmagnetic layer, a back-coat layer, or the like constituting the magnetic recording medium was appropriately reduced, thus decreasing the surface electric resistivity of the magnetic recording medium. As a result, the magnetic recording medium functioned as a static charge-removing path. In this way, the electrostatic destruction of the MR element was prevented.

A specific example of a method for reducing the surface electric resistivity is a method of incorporating conductive particles, such as carbon black, into at least one layer selected from the magnetic layer, the nonmagnetic layer, and the back-coat layer. That is, a three-dimensional structure of the carbon black particles in the layer is formed and serves as a static charge-removing path.

Alternatively, magnetic particles and nonmagnetic particles, which constitute the magnetic layer, the nonmagnetic layer, and the back-coat layer, in dispersions are coated with carbon or the like to form carbon-coated particles. As a result, in the same way as for the above-described method, a static charge-removing path is provided.

However, in the above-described methods of forming static charge-removing paths in the layers constituting the magnetic recording mediums, particles which do not contribute to electromagnetic conversion characteristics or which degrades electromagnetic conversion characteristics are added. Furthermore, the surface structure of the particles may degrade electromagnetic conversion characteristics.

That is, in various techniques proposed so far, for a magnetic read/write system using an MR element, there was no magnetic read/write system, which can prevent the electrostatic destruction of the element, achieving a good balance between satisfactory electromagnetic conversion characteristics and the stability of read/write characteristics.

Accordingly, with respect to a magnetic read/write system including a magnetic read/write apparatus having a flux guide MR head in combination with a magnetic recording medium, static charges (static electricity) accumulated on the head is removed through a static charge-removing path in the flux guide MR head to prevent the electrostatic destruction of the flux guide MR head instead of through a static charge-removing path in the magnetic recording medium.

According to an embodiment of the present invention, there is provided a magnetic read/write system including a magnetic read/write apparatus having a magnetoresistive head containing at least one flux guide; and a magnetic recording medium including a magnetic layer on a nonmagnetic support, the magnetoresistive head including a static charge-removing unit for removing static charges, the thickness of the magnetic layer constituting the magnetic recording medium being 0.3 μm or less, and the surface electric resistivity of the surface of the magnetic layer being in the range of 1×10⁸ to 1×10¹³ Ω/sq.

According to another embodiment of the present invention, there is provided a magnetic medium applied to a magnetic read/write apparatus including a magnetoresistive head having at least one flux guide, the magnetic medium including a magnetic layer on a nonmagnetic support, the magnetoresistive head including static charge-removing means for removing static charges, the thickness of the magnetic layer being 0.3 μm or less, and the surface electric resistivity of the surface of the magnetic layer being in the range of 1×10⁸ to 1×10¹³ Ω/sq.

According to another embodiment of the present invention, there is provided a magnetic read/write system including a magnetic read/write apparatus containing a magnetoresistive head having at least one flux guide; and a magnetic recording medium including a magnetic layer on a nonmagnetic support, the flux guide or a thin-film structure physically or electrically connected to the flux guide having a static charge-removing function of removing static charges in the magnetoresistive head, the thickness of the magnetic layer being 0.3 μm or less, and the surface electric resistivity of the surface of the magnetic layer being in the range of 1×10⁸ to 1×10¹³ Ω/sq.

According to another embodiment of the present invention, there is provided a magnetic medium applied to a magnetic read/write apparatus including a magnetoresistive head having at least one flux guide, the magnetic medium including a magnetic layer on a nonmagnetic support, the flux guide or a thin-film structure physically or electrically connected to the flux guide having a static charge-removing function of removing static charges in the magnetoresistive head, the thickness of the magnetic layer being 0.3 μm or less, and the surface electric resistivity of the surface of the magnetic layer being in the range of 1×10⁸ to 1×10¹³ Ω/sq.

According to another embodiment of the present invention, there is provided a magnetoresistive head including at least one flux guide, the flux guide or a thin-film structure physically or electrically connected to the flux guide having a function of removing static charges in the magnetoresistive head.

According to another embodiment of the present invention, there is provided a magnetic read/write system including a magnetic read/write apparatus containing a magnetoresistive head having at least one flux guide; and a magnetic recording medium including a magnetic layer on a nonmagnetic support, the flux guide or a thin-film structure physically or electrically connected to the flux guide being connected to an electrode or a conductor, the electrode or the conductor having a function of removing static charges in the magnetoresistive head, the thickness of the magnetic layer being 0.3 μm or less, and the surface electric resistivity of the surface of the magnetic layer being in the range of 1×10⁸ to 1×10¹³ Ω/sq.

According to another embodiment of the present invention, there is provided a magnetic medium applied to a magnetic read/write apparatus including a magnetoresistive head having at least one flux guide, the magnetic medium including a magnetic layer on a nonmagnetic support, the flux guide or a thin-film structure physically or electrically connected to the flux guide being connected to an electrode or a conductor, the electrode or the conductor having a function of removing static charges in the magnetoresistive head, the thickness of the magnetic layer being 0.3 μm or less, and the surface electric resistivity of the surface of the magnetic layer being in the range of 1×10⁸ to 1×10¹³ Ω/sq.

According to another embodiment of the present invention, there is provided a magnetoresistive head including at least one flux guide, the flux guide or a thin-film structure physically or electrically connected to the flux guide being connected to an electrode or a conductor, the electrode or the conductor having a function of removing static charges in the magnetoresistive head.

According to an embodiment of the present invention, it was possible to prevent a deterioration in electromagnetic conversion characteristics due to a static charge-removing path in a magnetic recording medium, and to improve the characteristics of high density recording.

Furthermore, according to an embodiment of the present invention, accumulated static electricity was efficiently removed not through a static charge-removing path in a magnetic recording medium but through a static charge-removing path in a flux guide MR head, thus preventing the electrostatic destruction of the head. Furthermore, it was possible to specially modify the composition and the surface shape of the magnetic recording medium so that the electromagnetic conversion characteristics were further improved.

### BRIEF DESCRIPTION OF THE DRAWINGS

FIG. 1 is a partially schematic cross-sectional view of a flux guide MR head according to an embodiment of the present invention;

FIG. 2 is a partially schematic perspective view of flux guide MR head according to an embodiment of the present invention;

FIG. 3 a partially schematic perspective view of flux guide MR head according to another embodiment of the present invention;

FIG. 4 is a partially schematic cross-sectional view of a flux guide MR head according to another embodiment of the present invention;

FIG. 5 is a partially schematic cross-sectional view of a flux guide MR head according to another embodiment of the present invention;

FIG. 6 is a partially schematic cross-sectional view of a flux guide MR head according to another embodiment of the present invention;

FIGS. 7 to 47 each are a perspective view illustrating the production process of a flux guide MR head according to an embodiment of the present invention;

FIG. 48 is a schematic view of a surface electric resistivity measuring unit; and

FIG. 49 is a schematic cross-sectional view of a known flux guide MR head.

### DESCRIPTION OF THE PREFERRED EMBODIMENTS

A flux guide MR head according to an embodiment of the present invention will be described in detail with reference to the drawings.

The flux guide MR head includes a structure for efficiently removing static charges, i.e., the flux guide MR head includes a static charge-removing path inside the flux guide MR head.

To be specific, a function of removing static charges is imparted to a flux guide included in the flux guide MR head or a thin-film structure physically or electrically adjacent to a flux guide.

An example of the head having the function of removing static charges is a flux guide MR head including a flux guide or a thin-film structure physically or electrically adjacent to a flux guide, the flux guide or the thin-film structure having at least one electrode or conductive element not for reading signals but for efficiently removing static charges in magnetic recording, the electrode or conductive element functioning as a static charge-removing path.

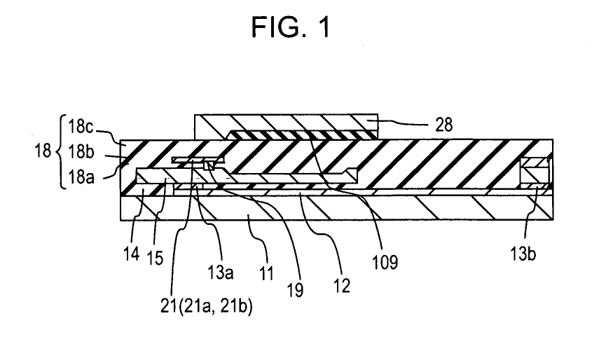

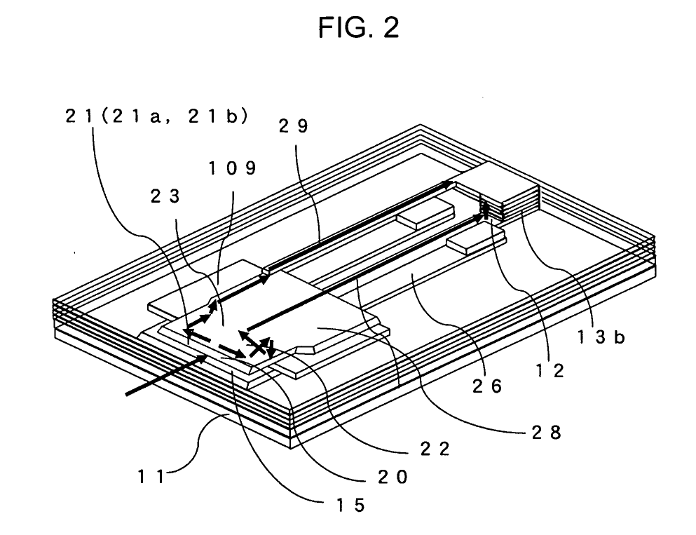

Fragmentary schematic views of a flux guide MR head according to an embodiment of the present invention are shown in FIG. 1 (cross-sectional view) and FIG. 2 (perspective view).

As shown in FIGS. 1 and 2, the flux guide MR head includes an external grounding terminal 13a adjacent to a bottom magnetic shield layer 15, the external grounding terminal 13a being composed of a metal; a static charge-removing path 12 adjacent to the external grounding terminal 13a; an external grounding terminal 13b adjacent to the static charge-removing path 12; and a static charge-removing path 29 adjacent to a top magnetic shield layer 28.

In an embodiment shown in FIGS. 1 and 2, in forming a first gap film 18a between the shield layers, the first gap film 18a being composed of a nonmagnetic, nonconductive material, a minute via hole 19 through the first gap film 18a is provided adjacent to a bias layer 21b, which is one of bias layers 21, of the flux guide. The bias layer 21b, which is one of the bias layers 21, is electrically connected to the bottom magnetic shield layer 15 with the via hole filled with a conductive material, such as a material constituting the bias layers 21.

On the other hand, a minute via hole through a second gap film 18b between the shield layers, a third gap film 18c between the shield layers, and a photoresist pattern 109 for insulating the top magnetic shield layer 28 from a MR element 22 and the flux guide is provided adjacent to a bias layer 21a, which is one of the bias layers 21. The bias layer 21a, which is another bias layer 21, is electrically connected to the top magnetic shield layer 28 with the via hole filled with a conductive material, such as a material constituting the top magnetic shield layer 28.

The top magnetic shield layer 28 is electrically connected to one of the bias layers 21.

In the above-described embodiment, the bias layer 21b is electrically connected to the bottom magnetic shield layer 15, and the bias layer 21a is connected to the top magnetic shield layer 28. However, the present invention is not limited to such a structure.

In the above-described flux guide MR head according to an embodiment of the present invention, when static charges generated at a medium-facing surface α1 of the MR head enter a flux guide 20, the static charges pass through the bias layer 21b being in contact with the flux guide 20, the bottom magnetic shield layer 15 being in contact with the bias layer 21b, the external grounding terminal 13a being in contact with the bottom magnetic shield layer 15, the static charge-removing path 12 adjacent to the external grounding terminal 13a, and the external grounding terminal 13b adjacent to the static charge-removing path 12 to be readily removed to the outside of the flux guide MR head (see arrows indicated in FIG. 2).

In a similar manner, when the static charges enter the flux guide 20, the static charges pass through the bias layer 21a being in contact with the flux guide 20, the top magnetic shield layer 28 being in contact with the bias layer 21a, and the static charge-removing path 29 adjacent to the top magnetic shield layer to be readily removed to the outside of the flux guide MR head (see arrows indicated in FIG. 2).

The above-described static charge-removing path as shown in FIG. 2 is an example and does not limit the present invention.

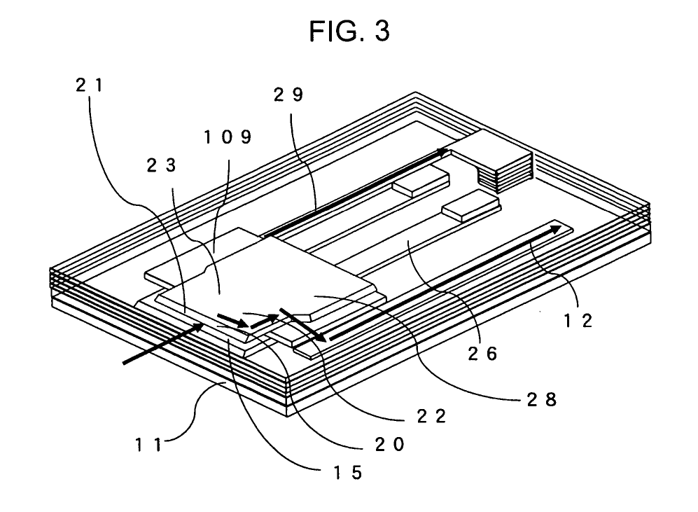

For example, as shown in FIG. 3, the static charge-removing path 12 is not in contact with the bottom magnetic shield layer and adjacent to the bias layers 21. In this case, static charges enter the flux guide 20 and pass through the bias layers 21 and then the static charge-removing path 12. Such a structure may be employed.

That is, any structure may be employed as long as the static charge-removing paths 12 and 29 are electrically connected to the bias layers 21.

As the MR element 22, for example, a spin-valve GMR element, which exhibits a giant magnetoresistive effect, may be applied. Use of the following element can also result in the same effect: an anisotropic magnetoresistive element (ANR element), which exhibits an anisotropic magnetoresistive effect; a GMR element having another structure; or a tunneling magnetoresistive element (TMR element), which exhibits a ferromagnetic tunneling magnetoresistive effect.

If the TMR element is used as the MR element 22, the resulting MR head should have a structure in which sense current flows in the direction perpendicular to the surfaces of the films constituting the TMR element.

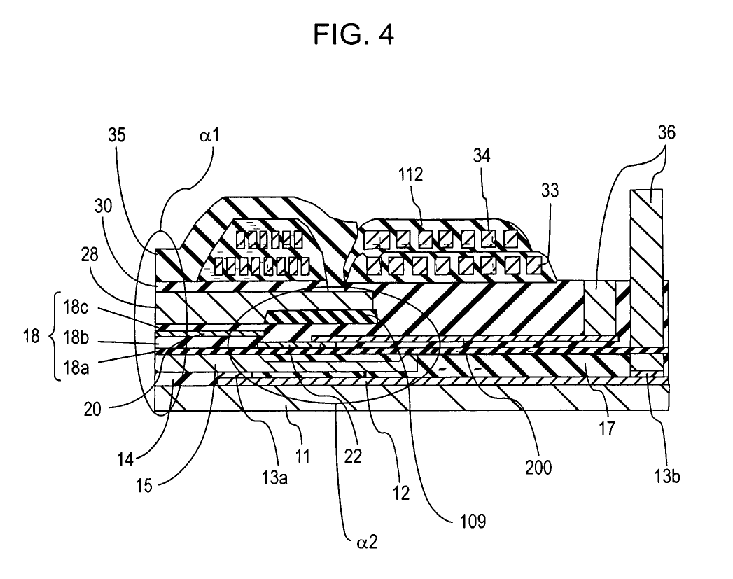

In detail, as shown in FIG. 4, an upper electrode 200 composed of a conductive material is provided on the second gap film 18b constituting a gap between shields 18. An end of the upper electrode 200 is connected to the upper surface of the MR element 22. An external terminal 36 is provided on the other end of the upper electrode 200.

In this MR head, the first gap film 18a constituting the gap between shields 18, i.e., the first gap film 18a directly below the MR element 22 is composed of a nonmagnetic, conductive material, such as tantalum, to serve as a lower electrode.

The end, remote from the medium-facing surface α1, of the first gap film 18a is connected to the external terminal 36.

For example, if the TMR element is used as the MR element 22, insulating bias layers for stabilizing the TMR element composed of, for example, Co-γ-Fe₂O₃ are sometimes provided at the ends of the TMR element instead of the bias layers 23a and 23b, also functioning as electrodes, composed of, for example, CoCrPt/TiW/Ta. However, this structure does not interfere with the true nature of the present invention.

For example, the TMR element is a laminate including an antiferromagnetic layer composed of an Fe—Mn alloy or the like, a pinned magnetic layer (pinned layer) composed of an Ni—Fe-based alloy, a Co-based alloy, a Co—Fe-based alloy, a Co—Ni-based alloy, an Ni—Fe—Co-based alloy, or the like, an insulating layer composed of Al₂O₃ or the like, a free magnetic layer (free layer) composed of a Ni—Fe-based alloy, a Co-based alloy, a Co—Fe-based alloy, a Co—Ni-based alloy, an Ni—Fe—Co-based alloy, or the like. These layers are stacked in that order on the first gap film 18a composed of nonmagnetic, conductive material in a manner such that the free layer is disposed at the closest position to the flux guide 20. This structure does not interfere with the true nature of the present invention. Any structure of the TMR element is within the scope of the invention.

Even when such a TMR element is used as the MR element 22, the static charge-removing paths 12 and 29 can be provided.

By electrically connecting the static charge-removing paths 12 and 29 with the bias layers 21 despite whether or not the bottom magnetic shield layer 15 and the top magnetic shield layer 28 are provided between the static charge-removing paths 12 and 29 with the bias layers 21, static charges entering through the flux guide 20 can be efficiently removed.

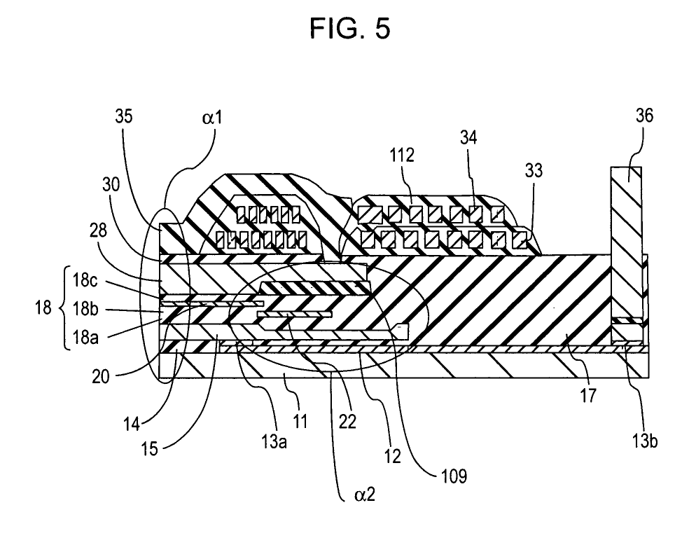

The above-described MR head including the MR element 22 disposed above the flux guide 20 has been described as an example but does not limit the present invention. For example, as shown in FIG. 5, even when the MR element 22 is provided below the flux guide 20, in other words, even when the MR element 22 is provided adjacent to the bottom magnetic shield layer 15 in the gap between shields 18, the resulting MR head can have the same effect as that in the example described above.

In a magnetosensitive portion α2 shown in FIG. 5, the flux guide 20 is disposed between the bottom magnetic shield layer 15 and the top magnetic shield layer 28.

The MR element 22 is disposed below the flux guide 20, in other words, the MR element 22 is disposed adjacent to the bottom magnetic shield layer 15 in the gap between shields 18.

Thus, the distance between the MR element 22 and the bottom magnetic shield layer 15 is unsatisfactory to ensure electrical and magnetic insulation, in some cases.

In this case, to ensure the distance between the MR element 22 and the bottom magnetic shield layer 15, a groove may be provided at a portion of the bottom magnetic shield layer 15 corresponding to the MR element 22, i.e., at a portion of the bottom magnetic shield layer 15 overlapping with the MR element 22 in the stacking direction.

In this way, the groove is provided at the portion of the bottom magnetic shield layer 15 corresponding to the MR element 22 to ensure the distance between the MR element 22 and the bottom magnetic shield layer 15, thereby successfully preventing leakage of a signal magnetic field, which is transmitted from the flux guide 20 to the MR element 22, into the bottom magnetic shield layer 15 and thus preventing a reduction in the efficiency of the transmission of the signal magnetic field from the flux guide 20 to the MR element 22. Furthermore, undesirable destruction of the MR element 22 caused by an electrical short circuit between the MR element 22 and the bottom magnetic shield layer 15 can be effectively prevented.

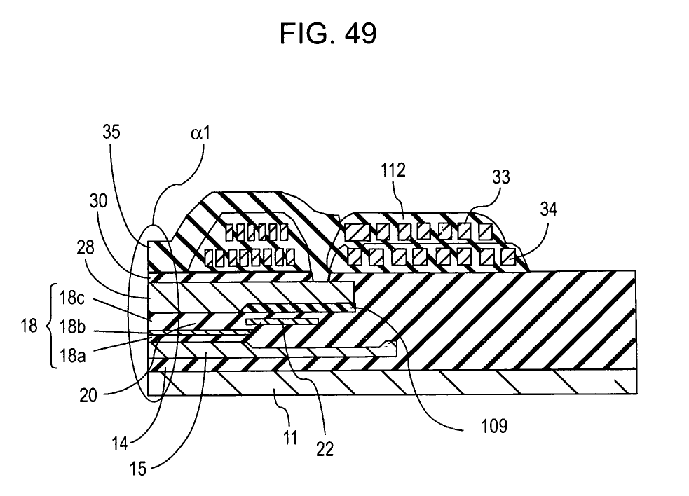

In the MR element having a known structure shown in FIG. 49 and the MR element according to an embodiment of the present invention, the MR element 22 and the flux guide 20 are provided at different positions in the stacking direction in the magnetosensitive portion. That is, the MR element 22 overlaps with the flux guide 20 in the stacking direction.

This structure results in that the MR element 22 and the flux guide 20 can be disposed at a very short distance from each other with high accuracy and that the transmission efficiency of the signal magnetic field from the flux guide 20 to the MR element 22 can be significantly effective. However, the present invention is not limited to the structure of such an MR element.

A structure in which the MR element 22 and the flux guide 20 are provided at different positions in the stacking direction and the MR element 22 does not overlap with the flux guide 20 in the magnetosensitive portion α2 may be used.

The MR element 22 and the flux guide 20 may be provided at the same position in the stacking direction in the magnetosensitive portion α2.

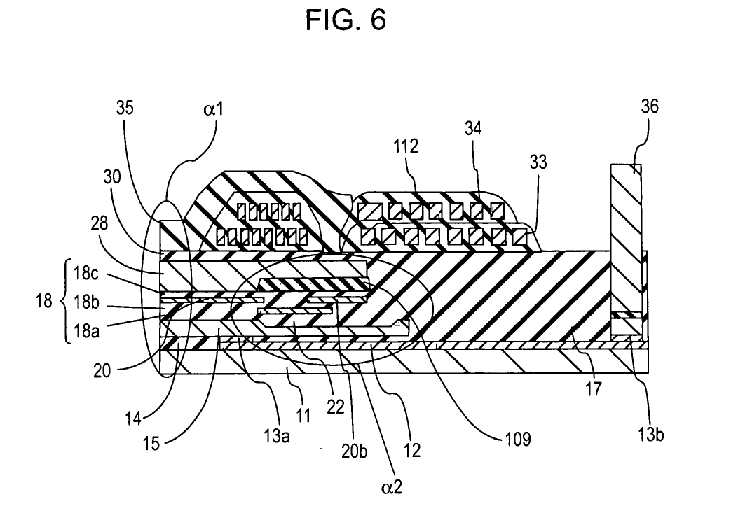

As shown in FIG. 6, a second flux guide 20b may be provided at a position remote from the medium-facing surface α1 in a manner such that the MR element 22 is provided between the second flux guide 20b and the medium-facing surface α1.

The second flux guide 20b may be provided on the second gap film 18b (electrically insulating film) constituting the gap between shields 18 in a manner such that the portion of the second flux guide 20b adjacent to the medium-facing surface α1 partially overlaps with the portion of the MR element 22 remote from the medium-facing surface α1 with the second gap film.

Such structures are only examples of the flux guide MR head according to an embodiment of the present invention. The scope of the flux guide MR head according to an embodiment of the present invention is not limited to any structure of the magnetosensitive portion α2 included in the flux guide MR head.

In this way, in the flux guide MR head having any structure of the magnetosensitive portion α2 according to an embodiment of the present invention, the MR head advantageously has a function of efficiently removing static charges therein, thereby eliminating the need for imparting this function of removing static charges to a magnetic recording medium. As a result, a deterioration in read/write characteristics can be prevented. Consequently, the integrated system of a magnetic recording medium and the head could be provided while achieving a good balance between improved read/write characteristics and high reliability because of no destruction of the head due to static electricity.

A process for producing a flux guide MR head, shown in FIG. 2, according to an embodiment of the present invention will be described below.

A nonmagnetic substrate (first substrate 11) having an oxide film on the surface thereof is prepared.

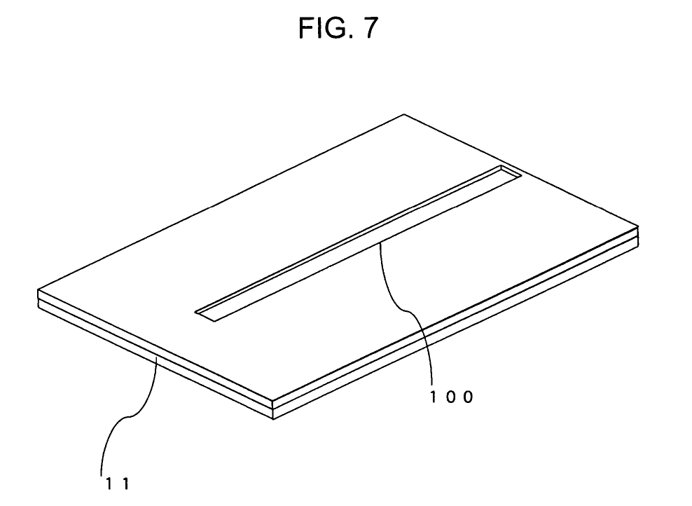

As shown in FIG. 7, a photoresist pattern 100 for forming an electrode serving as a ground for the bottom magnetic shield layer 15 is formed on the first substrate 11 by photolithography.

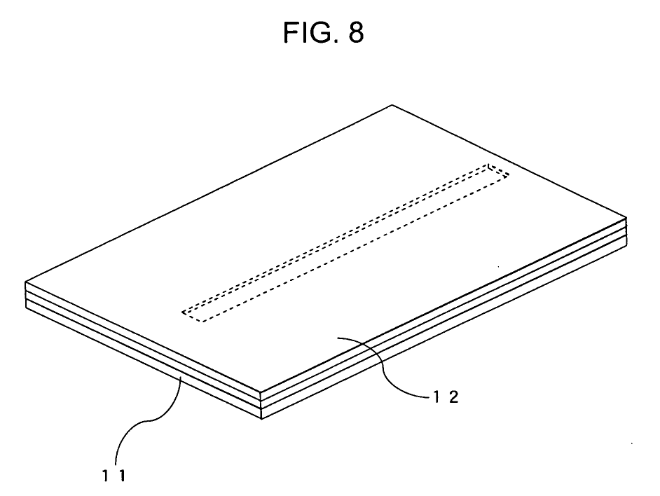

As shown in FIG. 8, a conductive film 12 ultimately functioning as a ground for the bottom magnetic shield layer 15 is formed on the photoresist pattern 100 by sputtering or the like.

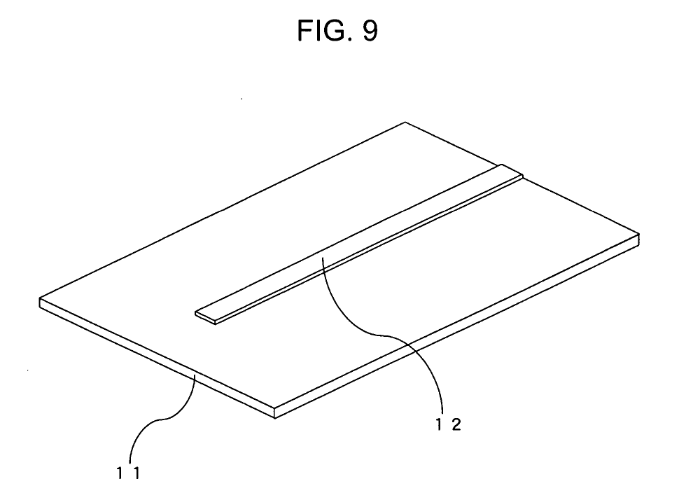

By removing the conductive film 12 formed on the photoresist pattern 100 by lift-off processing together with the photoresist pattern 100, an electrode 12 functioning as the ground for the bottom magnetic shield layer 15 is formed as shown in FIG. 9.

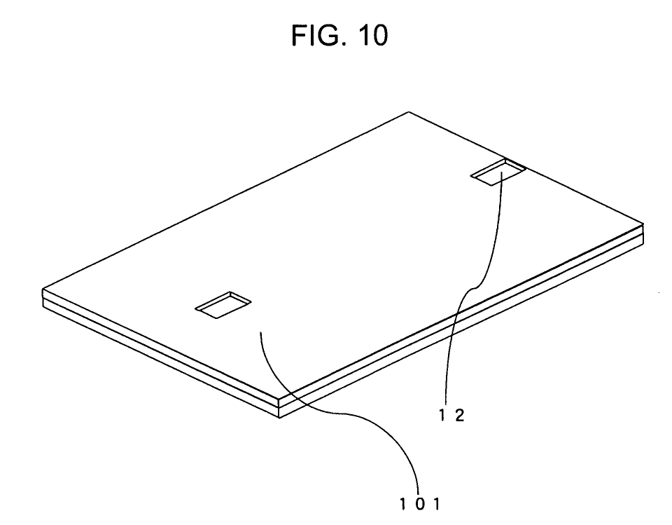

As shown in FIG. 10, an external terminal pattern 101 is formed by photolithography.

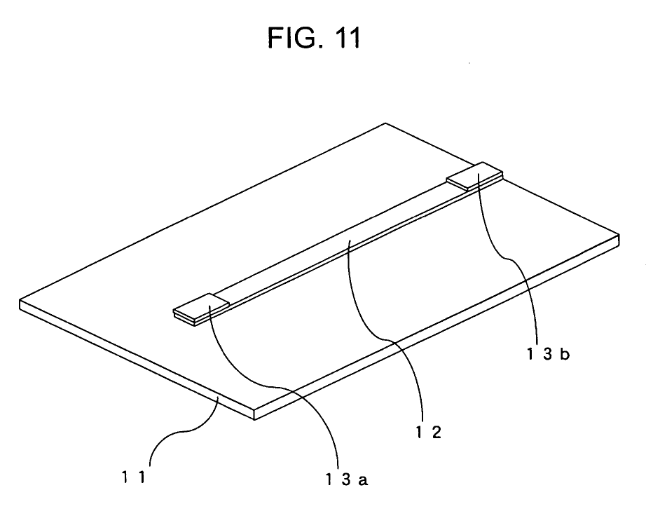

As shown in FIG. 11, external terminals 13a and 13b each composed of a conductive material and each having a thickness of, for example, about 3 μm are formed on the electrode 12 (grounding electrode) by plating or the like.

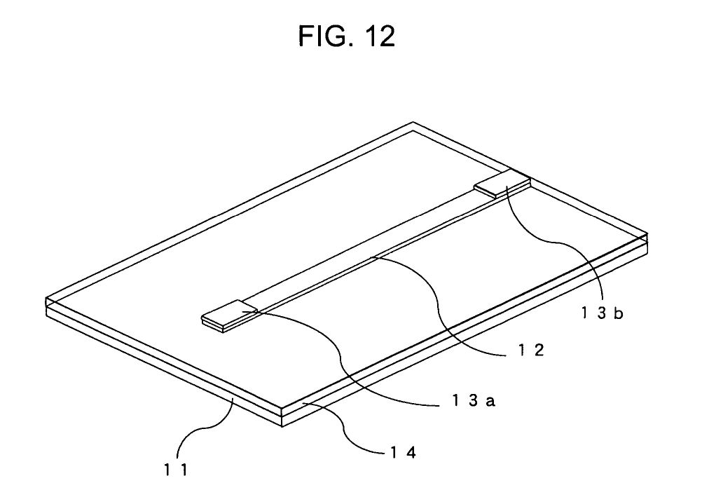

As shown in FIG. 12, a nonmagnetic, nonconductive film 14 composed of Al₂O₃ or the like and having a thickness of, for example, about 2 μm is formed on the grounding electrode 12 by sputtering or the like.

The resulting nonmagnetic, nonconductive film 14 is polished by, for example, lapping with abrasive diamond grain or chemical polishing to expose the top faces of the external grounding terminals 13a and 13b. As a result, as shown in FIG. 12, the nonmagnetic, nonconductive film 14 has a planarized surface and covers the grounding electrode 12. The external grounding terminals 13a and 13b are electrically continuous.

A soft magnetic thin film 15 composed of a Ni—Fe-based alloy, a Fe—Si—Al-based alloy, or the like and having a thickness of, for example, about 3 μm is formed on the nonmagnetic, nonconductive film 14 and the top faces of the external grounding terminals 13a and 13b by sputtering, plating, or the like.

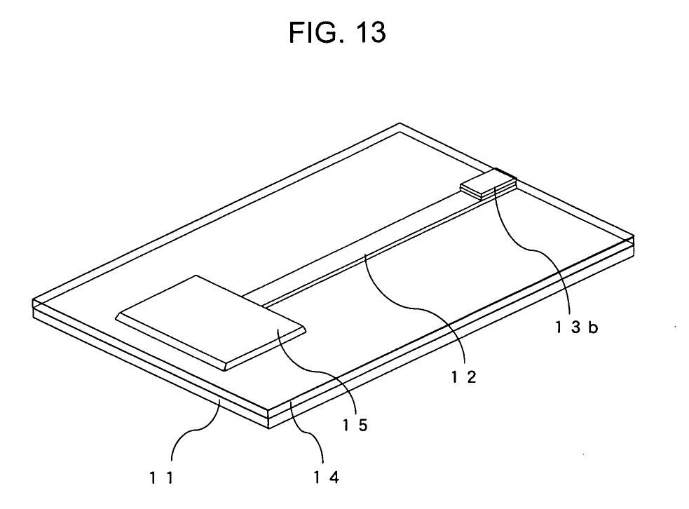

The resulting soft magnetic thin film 15 is processed into a predetermined shape by photolithography and ion etching. As a result, as shown in FIG. 13, the bottom magnetic shield layer 15 is provided on the nonmagnetic, nonconductive film 14 and the external grounding terminal 13a while the top surface of the external grounding terminal 13b is exposed. The external grounding terminal 13a is electrically continuous to the bottom magnetic shield layer 15.

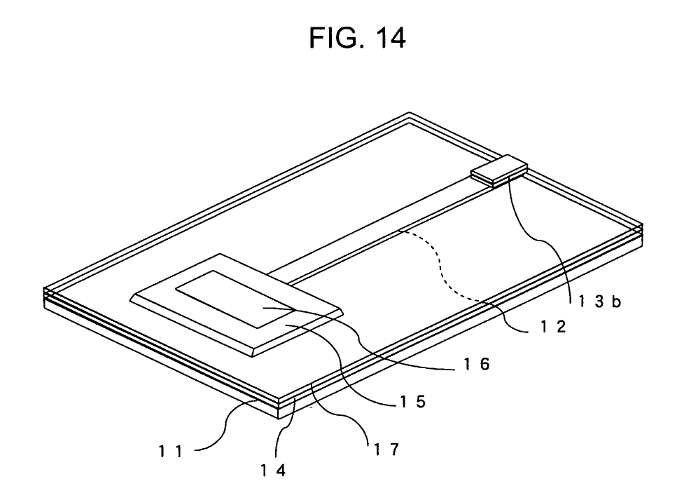

As shown in FIG. 14, a groove 16 having a depth of, for example, about 1 μm is formed in the bottom magnetic shield layer 15 by photolithography and ion etching.

In the photolithography step, a photoresist is heated under predetermined conditions such that the cross section of the photoresist is inclined. Then, ion etching is performed to form the groove 16.

As a result, the groove 16 has side walls each having an inclination of, for example, about 45°.

A nonmagnetic, nonconductive film 17 composed of Al₂O₃ or the like and having a thickness of, for example, about 2.5 μm is formed by sputtering or the like.

The nonmagnetic, nonconductive film 17 is polished by lapping with abrasive diamond grain, chemical polishing, or the like to expose the top face of the bottom magnetic shield layer 15.

As a result, the groove 16 is filled with the nonmagnetic, nonconductive film 17, and the surface of the nonmagnetic, nonconductive film 17 is planarized.

A nonmagnetic, nonconductive film 18 composed of Al₂O₃ or the like and having a predetermined thickness is formed on the bottom magnetic shield layer 15, which has the groove 16 filled with the nonmagnetic, nonconductive film 17, by sputtering or the like and then polished in a manner such that the thickness is, for example, about 42.5 nm.

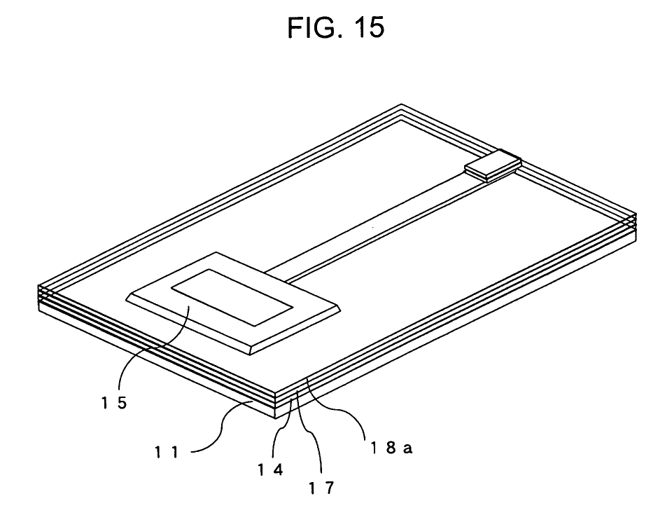

As a result, as shown in FIG. 15, the first gap film 18a that will constitute the gap between shields 18 is provided on the bottom magnetic shield layer 15.

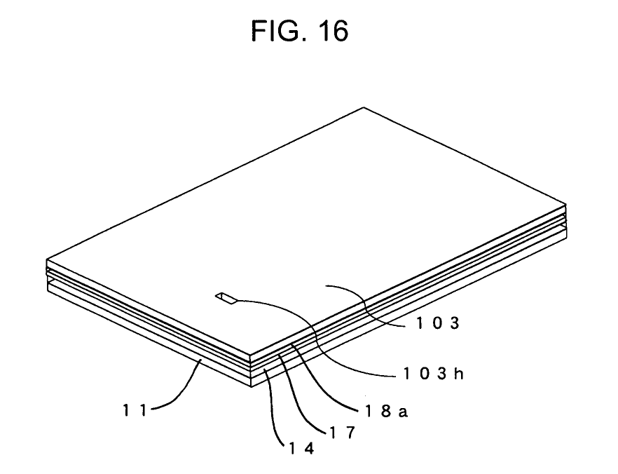

As shown in FIG. 16, in order to connect the bottom magnetic shield layer 15 and the flux guide 20, a photoresist pattern 103 is formed on the first gap film 18a by photolithography. The photoresist pattern 103 has an opening 103h at a position where a via hole for connecting the bottom magnetic shield layer 15 with the flux guide 20 will be provided.

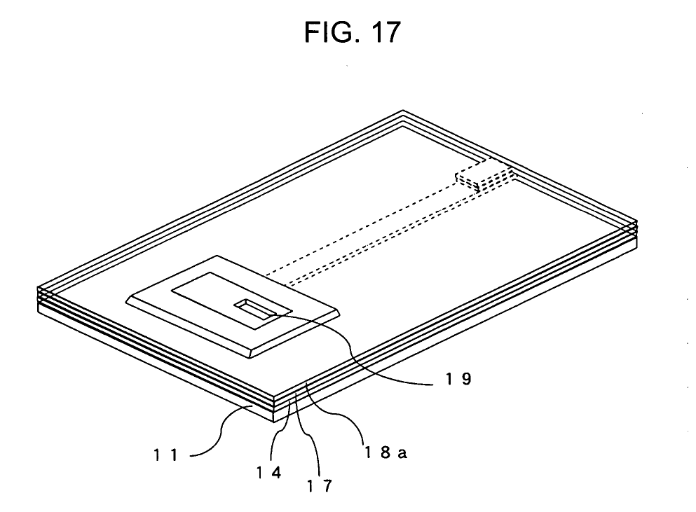

Ion etching is performed using the photoresist pattern 103 as a mask to form the via hole 19 for connecting the bottom magnetic shield layer 15 with the flux guide as shown in FIG. 17.

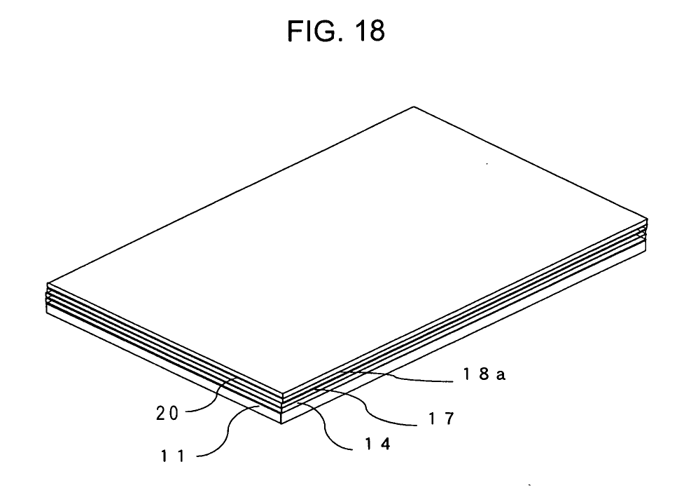

As shown in FIG. 18, a soft magnetic film 20 ultimately functioning as the flux guide 20 is formed on the first gap film 18a having the via hole 19 by sputtering or the like, the soft magnetic film 20 being composed of an Ni—Fe-based alloy or the like and having a thickness of, for example, about 30 nm.

The magnetic anisotropy of the soft magnetic film 20 is controlled in a manner such that the easy magnetization axis of the flux guide 20 to be ultimately obtained is in parallel with a medium contact surface 1a.

The magnetic anisotropy of the soft magnetic film 20 can be controlled by the following process: for example, a process of forming the soft magnetic film 20 by sputtering in a magnetic field; or a process of forming the soft magnetic film 20 on the first gap film 18a and then subjecting the resulting soft magnetic film 20 to static field anneal.

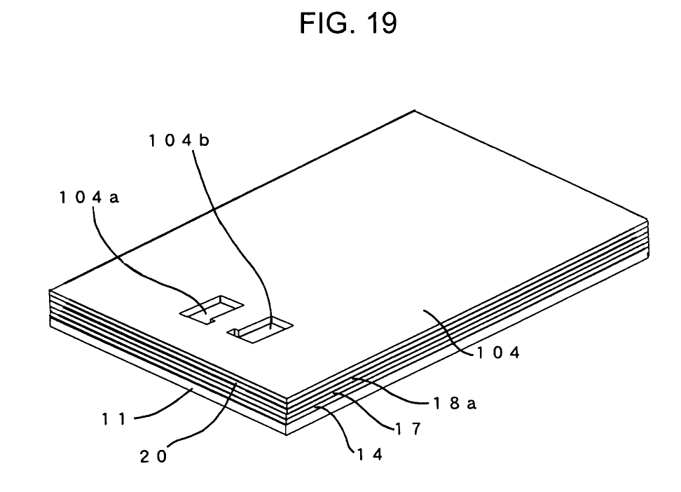

As shown in FIG. 19, a photoresist pattern 104 for forming the pair of bias layers 21a and 21b is formed on the soft magnetic film 20 by photolithography.

The photoresist pattern 104 has openings 104a and 104b at positions where the bias layers 21a and 21b are provided.

Ion etching is performed using the photoresist pattern 104 as a mask to remove the soft magnetic film 20 at the positions where the bias layers 21a and 21b are provided.

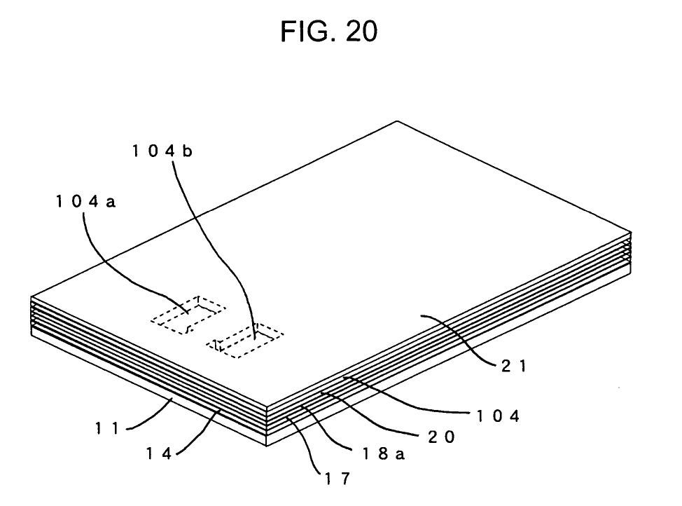

As shown in FIG. 20, a ferromagnetic film 21 ultimately functioning as bias layers 21a and 21b is formed on the photoresist pattern 104 by sputtering or the like, the ferromagnetic film 21 being composed of a CoCrPt alloy or the like and having a thickness of, for example, about 50 nm.

At the positions where the openings 104a and 104b of the photoresist pattern 104 is provided, i.e., at the positions where the bias layers 21a and 21b will be provided, the soft magnetic film 20 is removed. Therefore, the ferromagnetic film 21 that will be bias layers 21a and 21b is formed on the first gap film 18a that will constitute the gap between shields 18.

At this time, the bottom magnetic shield layer and the ferromagnetic film 21 are electrically continuous.

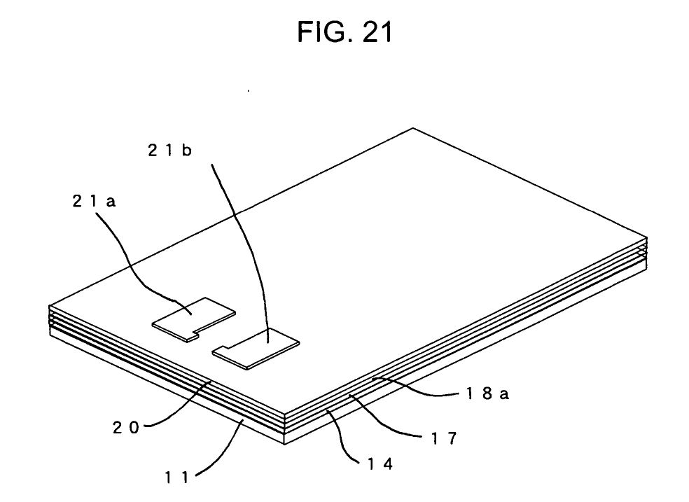

The ferromagnetic film 21 formed on the photoresist pattern 104 is removed by lift-off processing together with the photoresist pattern 104. As a result, as shown in FIG. 21, the bias layers 21a and 21b are provided in the soft magnetic film 20.

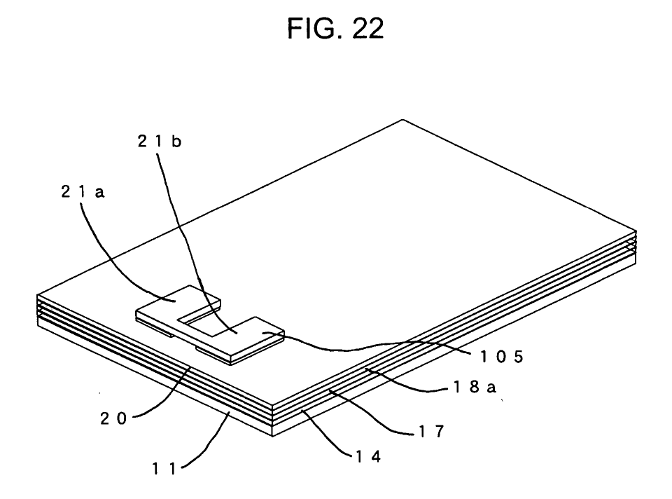

As shown in FIG. 22, a photoresist pattern 105 for forming a flux guide is formed over the bias layers 21a and 21b and the soft magnetic film 20 by photolithography.

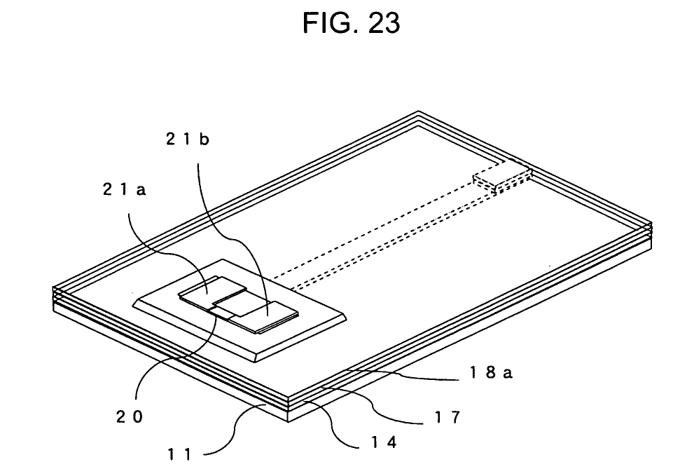

Ion etching is performed using the photoresist pattern 105 as a mask to remove the soft magnetic film 20 other than a portion where the flux guide 20 is formed, thereby forming the flux guide 20 connected to the bias layers 21a and 21b as shown in FIG. 23.

After the flux guide 20 is formed on the first gap film 18a and between the bias layers 21a and 21b, a nonmagnetic, nonconductive film 18b composed of Al₂O₃ or the like and having a predetermined thickness is formed by sputtering or the like. The resulting nonmagnetic, nonconductive film 18b is polished by chemical polishing or the like in a manner such that the thickness of the nonmagnetic, nonconductive film 18b on the flux guide 20 is about 42.5 nm. In other words, the nonmagnetic, nonconductive film 18b is polished in a manner such that the distance between the top face of the bottom magnetic shield layer 15 and the top face of the nonmagnetic, nonconductive film is 135 nm.

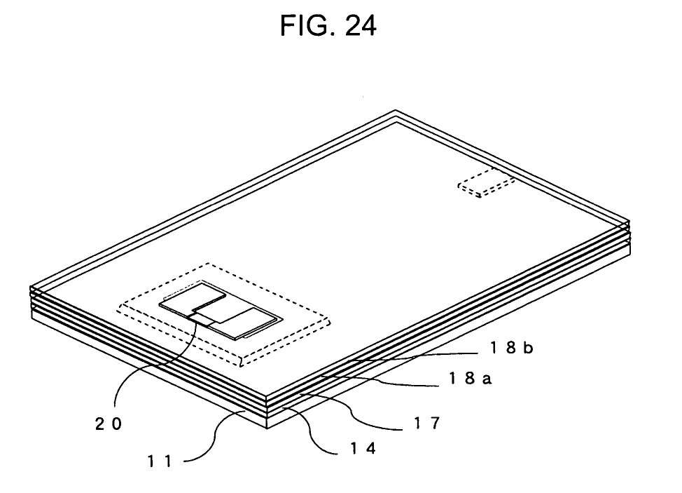

As a result, as shown in FIG. 24, the second gap film 18b is provided on the first gap film 18a and covers the flux guide 20.

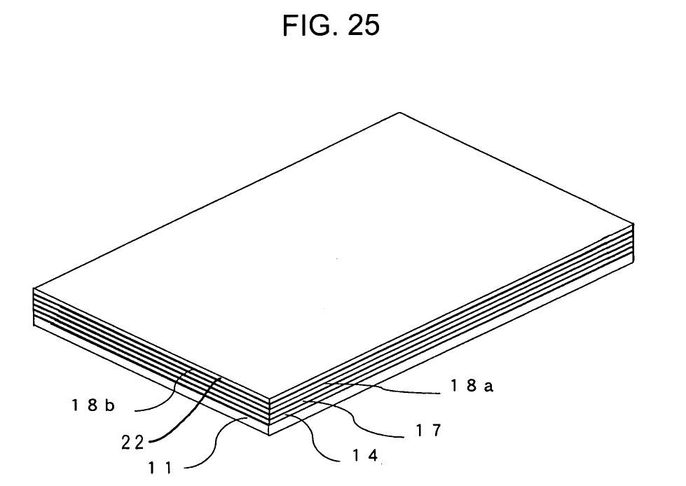

As shown in FIG. 25, a laminated film 22, having a thickness of, for example, 50 nm, ultimately serving as a spin-valve GMR element (MR element) is formed on the planarized second gap film 18b by sputtering or the like.

The laminated film 22 is formed in a manner such that the easy magnetization axis of the free layer of the GMR element to be ultimately obtained is parallel to the medium contact surface 1a and the easy magnetization axis of the pinned layer is perpendicular to the medium contact surface 1a without a magnetic field.

Furthermore, the free layer is disposed as the lowermost layer so as to be provided at the closest position to the flux guide 20.

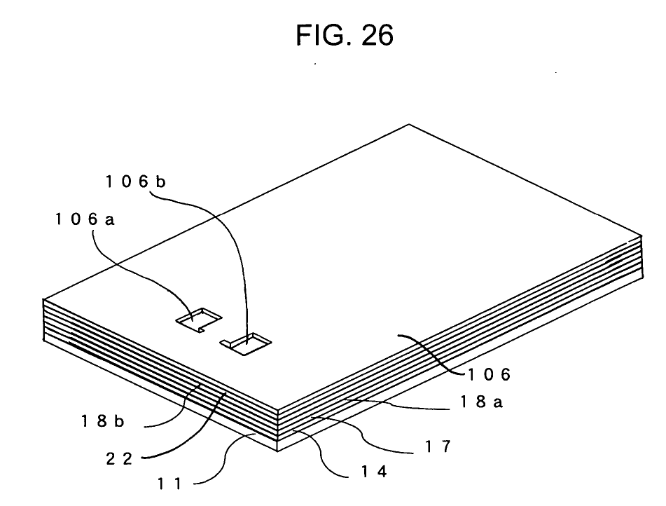

As shown in FIG. 26, a photoresist pattern 106 for forming bias layers 23a and 23b, which are also serving as electrode layers, is formed on the laminated film 22 by photolithography.

The photoresist pattern 106 has openings 106a and 106b at positions where the bias (electrode) layers 23a and 23b will be formed.

Then, ion etching is performed using the photoresist pattern 106 as a mask to remove the laminated film 22 at the positions where the bias layers 23a and 23b will be formed.

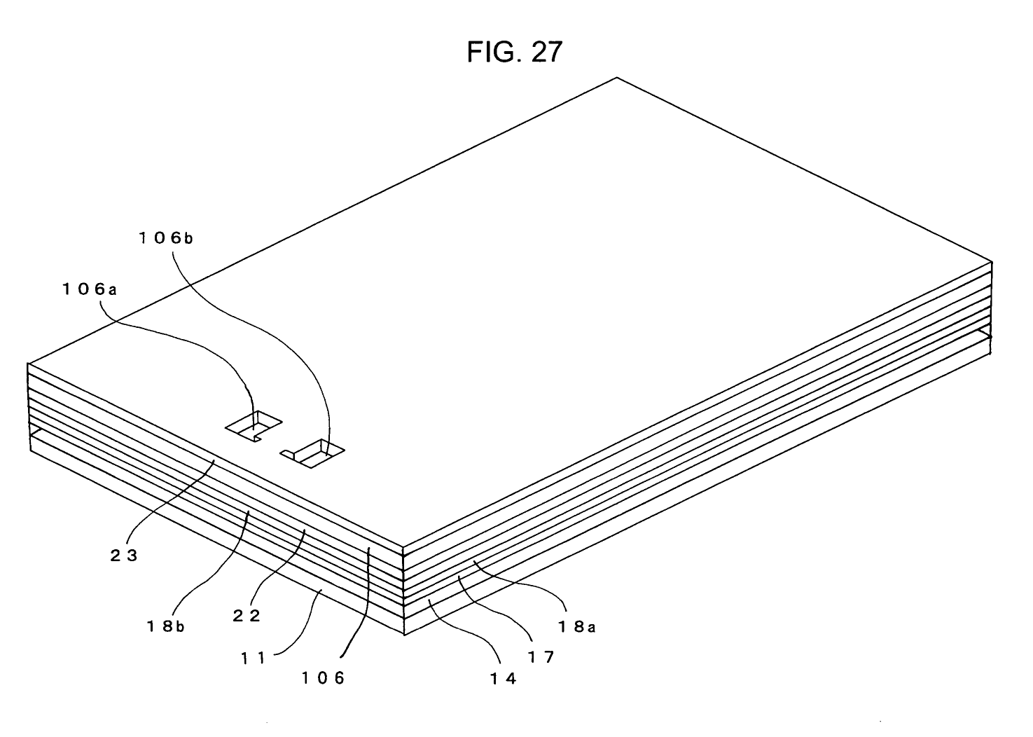

As shown in FIG. 27, a laminated film 23 ultimately serving as the bias layers 23a and 23b is formed on the photoresist pattern 106 by sputtering or the like, the laminated film 23 being composed of CoCrPt/TiW/Ta or the like and having a thickness of, for example, about 50 nm.

At the positions where the openings 106a and 106b of the photoresist pattern 106 is provided, i.e., at the positions where the bias (electrode) layers 23a and 23b will be provided, the laminated film 22 ultimately serving as the MR element is removed. Therefore, the laminated film 23 that will be bias (electrode) layers 23a and 23b is formed on the second gap film 18b.

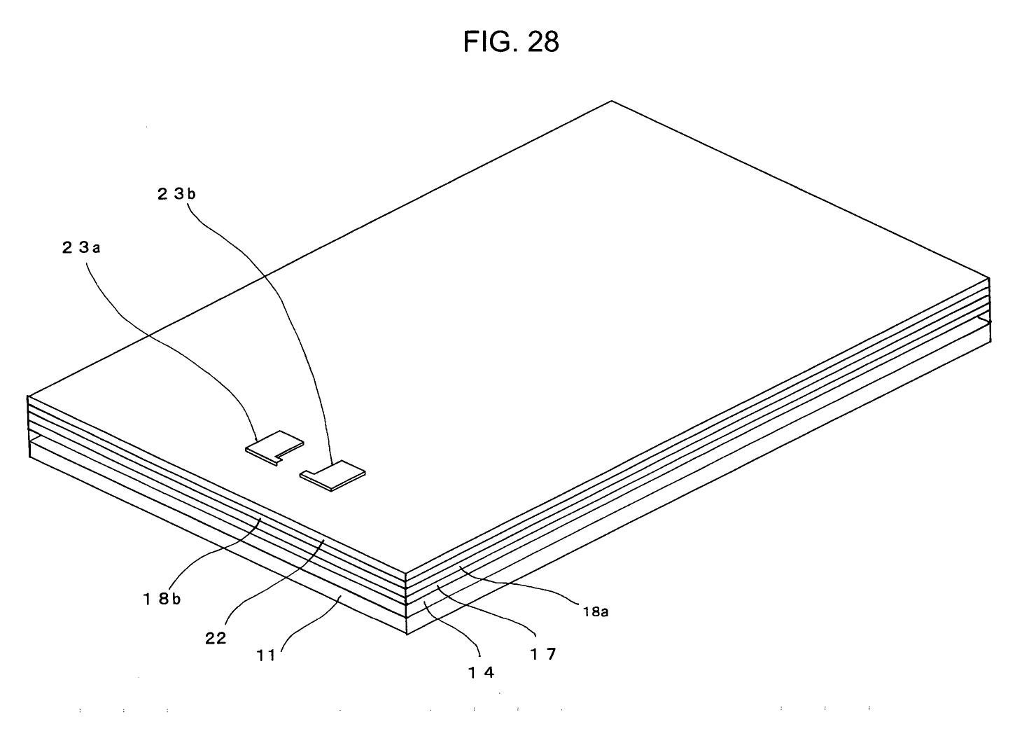

The laminated film 23 on the photoresist pattern 106 is removed by lift-off processing together with the photoresist pattern 106. As a result, as shown in FIG. 28, the bias (electrode) layers 23a and 23b are provided in the laminated film 22.

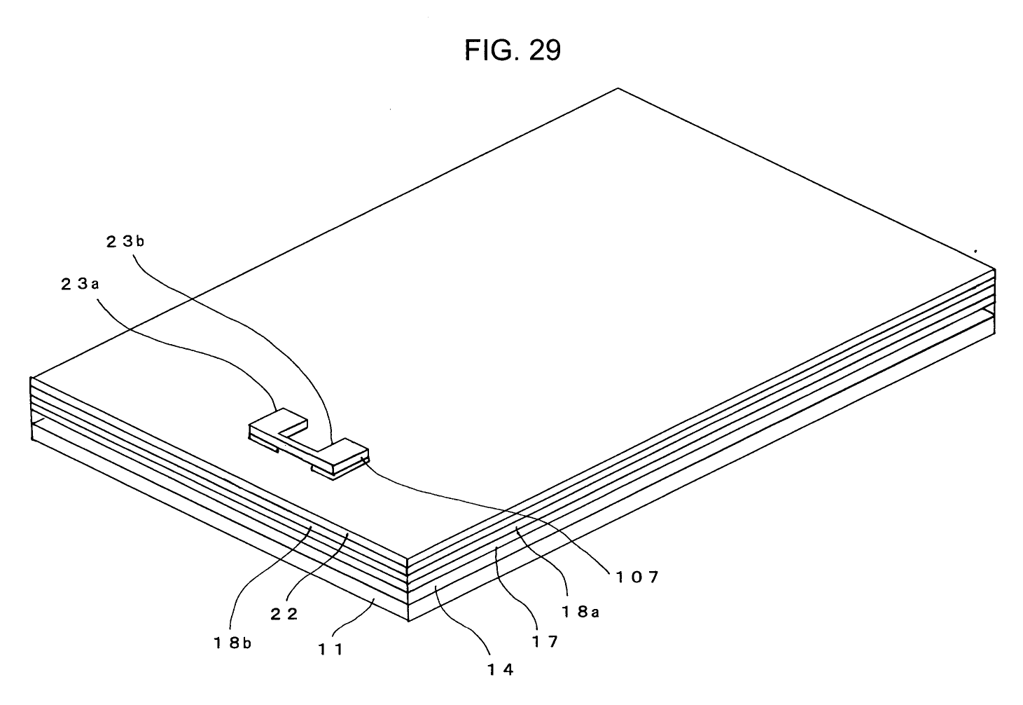

As shown in FIG. 29, a photoresist pattern 107 for forming the MR element is formed over the bias layers 23a and 23b and the laminated film 22 by photolithography.

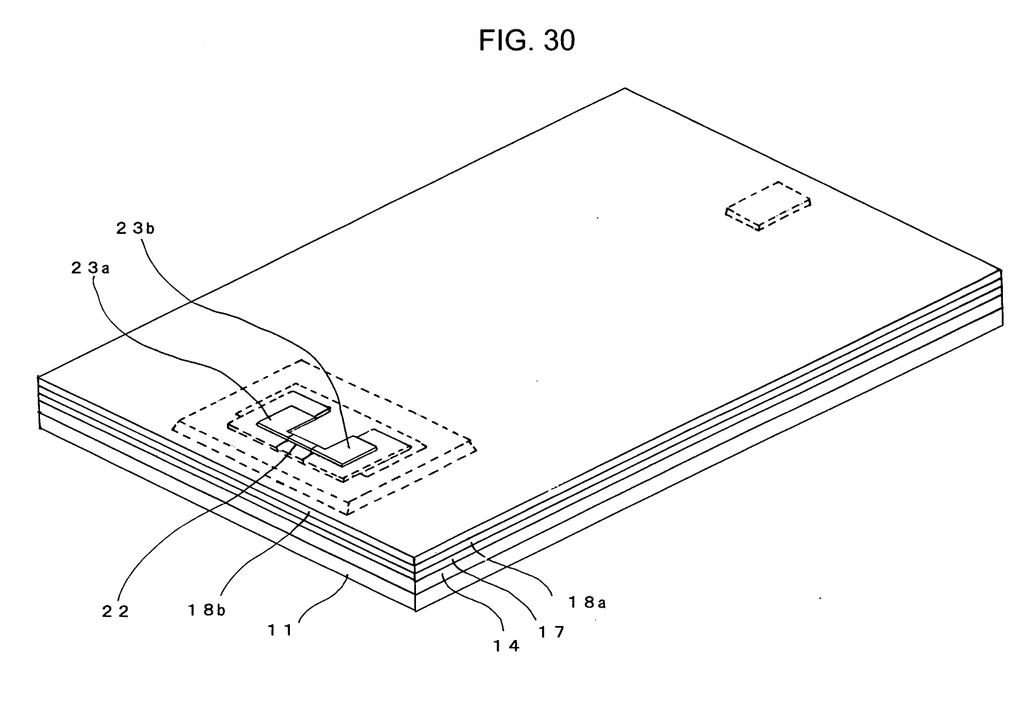

Then, ion etching is performed using the photoresist pattern 107 as a mask to remove the laminated film other than the portion where the MR element will be formed, thereby providing the MR element 22 connected to the bias (electrode) layers 23a and 23b as shown in FIG. 30.

A nonmagnetic, nonconductive film 18c composed of Al₂O₃ and having a predetermined thickness is formed on the second gap film 18b including the MR element 22 connected to the bias (electrode) layers 23a and 23b by sputtering or the like. Then, the resulting nonmagnetic, nonconductive film 18c is polished by chemical polishing in a manner such that the thickness of the nonmagnetic, nonconductive film 18c on the MR element 22 is about 135 nm.

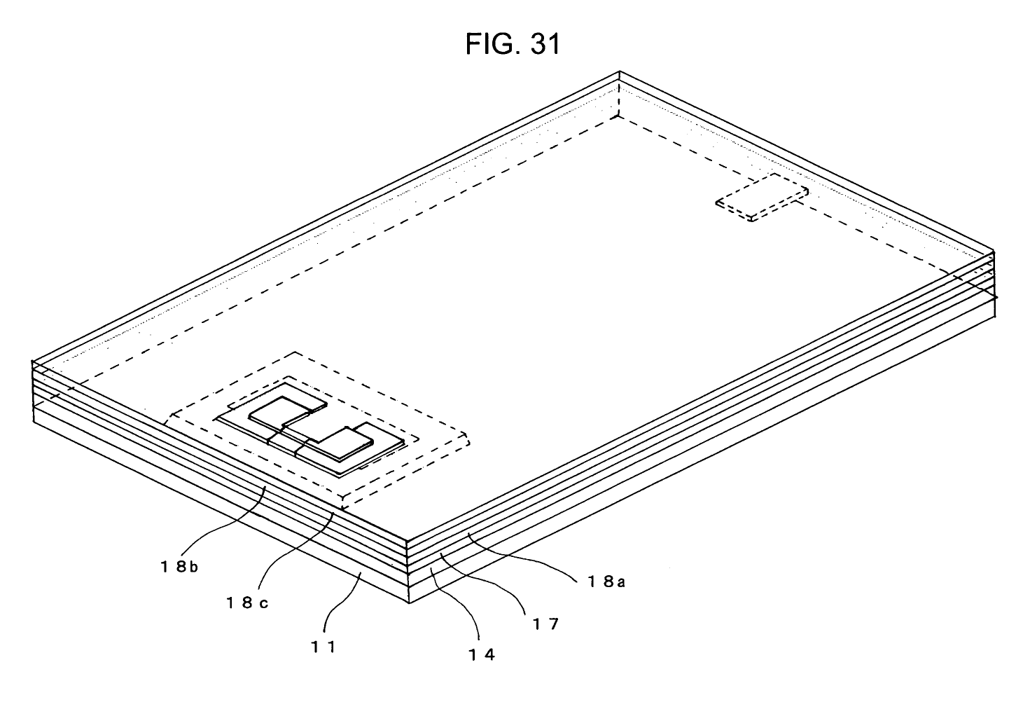

As a result, as shown in FIG. 31, the third gap film 18c is provided on the second gap film 18b and covers the MR element 22.

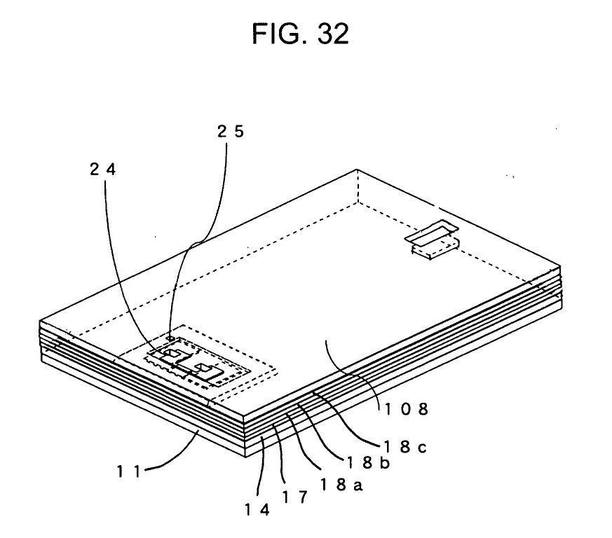

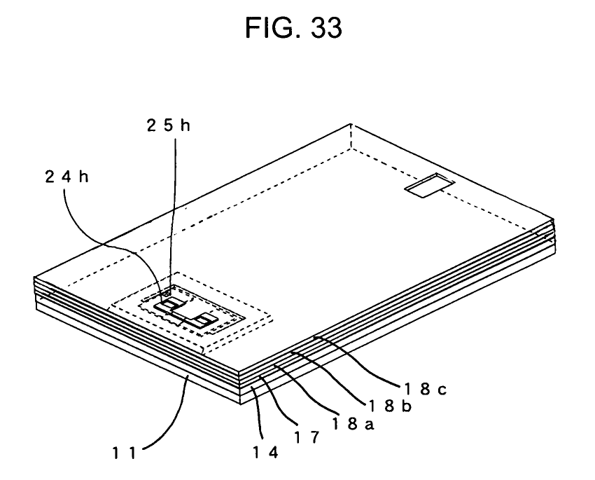

As shown in FIG. 32, a photoresist pattern 108 for forming a via hole 24 for connecting the MR element 22 with electrodes 26 described below and for forming a via hole 25 for connecting the flux guide with the an electrode 27 described below is formed on the third gap film 18c by photolithography.

Then, ion etching is performed using the photoresist pattern 108 as a mask to form a via hole 24h for connecting the MR element 22 with the electrodes 26 and a via hole 25h for connecting the flux guide 20 with the electrode 27.

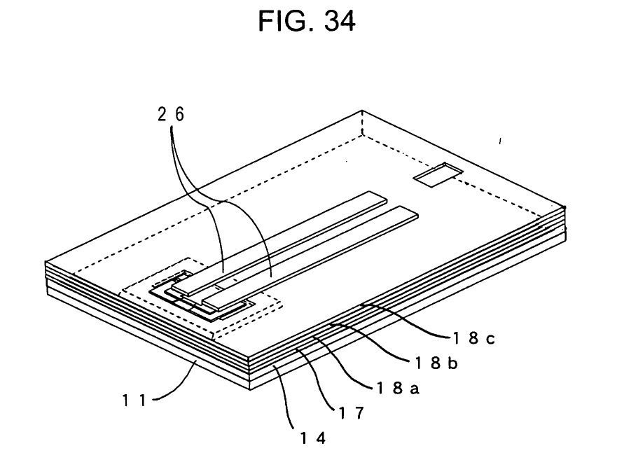

The electrodes 26 for connecting the MR element 22 with the external terminals 36 described below are formed into the shapes shown in FIG. 34 by photolithography, sputtering, or the like.

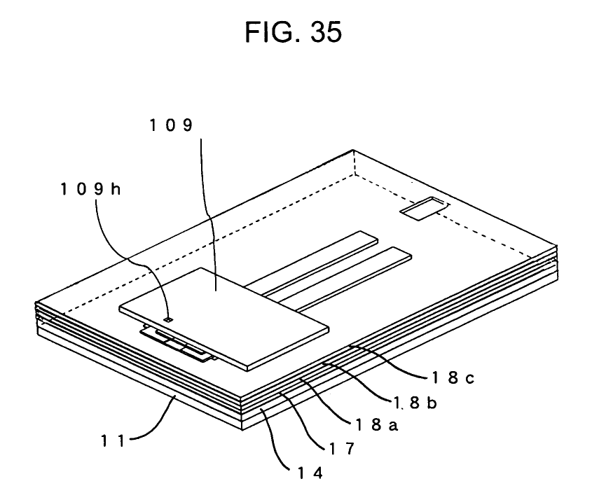

As shown in FIG. 35, the photoresist pattern 109 for insulating the electrodes 26 composed of a conductive material from the intermediate magnetic shield layer 28 is formed by photolithography.

At the same time, a via hole 109h for connecting the flux guide 20 with the intermediate magnetic shield layer 28 is formed in the photoresist pattern 109.

Furthermore, this photoresist pattern 109 is heat-treated into an electrical insulating layer.

A soft magnetic thin film 28 composed of an amorphous Ni—Fe-based alloy, an amorphous ZrNbTa alloy, a Fe—Si—Al-based alloy, or the like and having a thickness of, for example, about 3 μm is formed on the heat-treated photoresist pattern 109 by sputtering, plating, or the like.

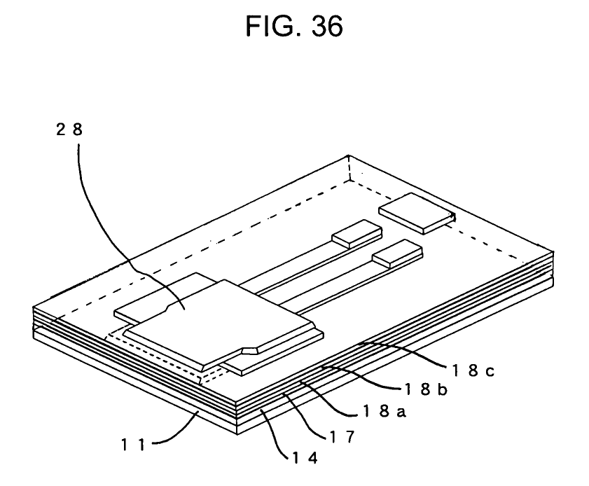

The resulting soft magnetic thin film 28 is processed into a predetermined shape by photolithography and ion etching to form the intermediate magnetic shield layer 28 on the third gap film 18c as shown in FIG. 36.

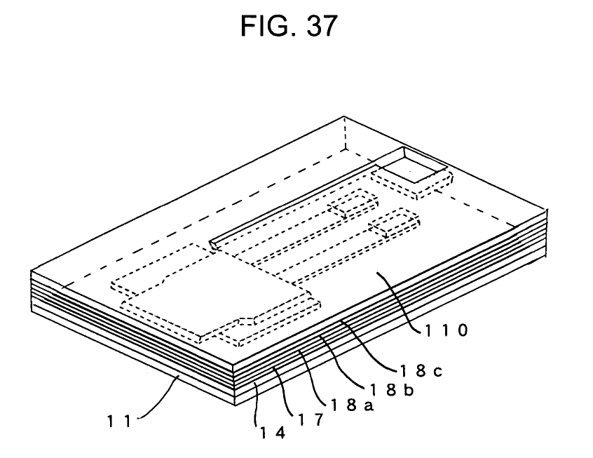

As shown in FIG. 37, a photoresist pattern 110 for forming an electrode serving as a ground for the intermediate magnetic shield layer 28 is formed on the intermediate magnetic shield layer 28.

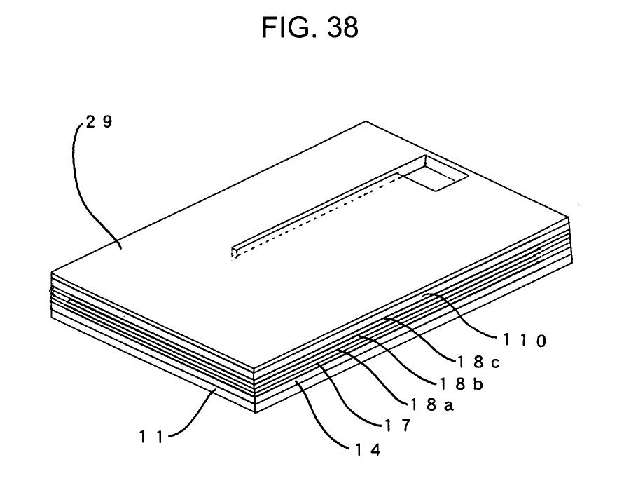

As shown in FIG. 38, a conductive film 29 ultimately serving as a grounding electrode for the intermediate magnetic shield layer 28 is formed on the photoresist pattern 110 by sputtering or the like.

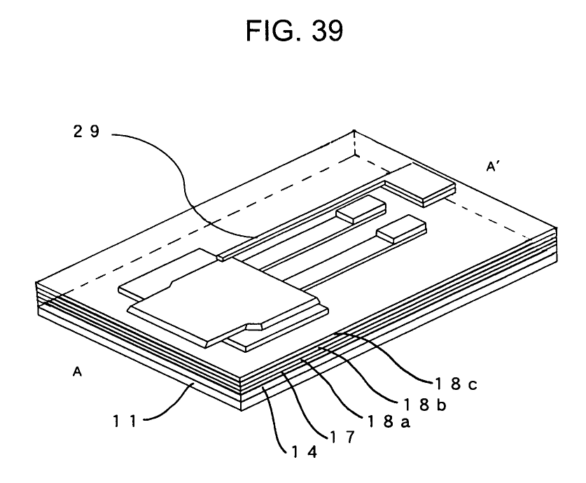

The resulting conductive film 29 on the photoresist pattern 110 is removed by lift-off processing together with the photoresist pattern 110 to form the static charge-removing path 29 serving as a ground for the intermediate magnetic shield layer 28 as shown in FIG. 39.

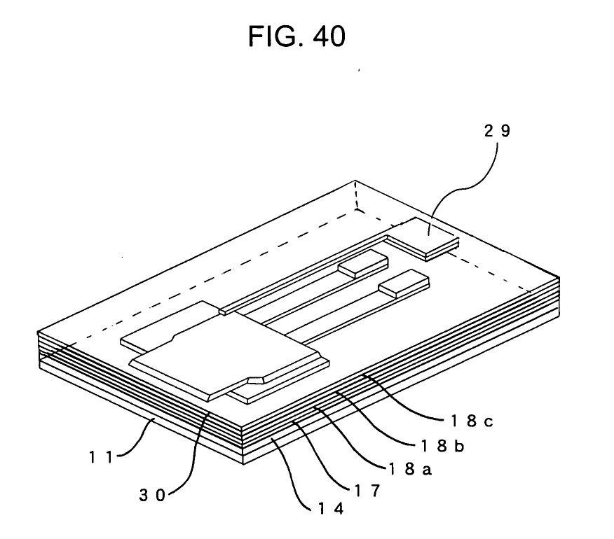

Then, a nonmagnetic, nonconductive film composed of Al₂O₃ or the like and having a predetermined thickness is formed by sputtering or the like. As a result, as shown in FIG. 40, a fourth gap film 30 that will constitute the gap between shields 18 is provided.

A process for producing a portion, which contributes to reading, of a flux guide MR head has been described above.

In general, a read head in a helical-scan magnetic read/write system, which includes a write head and a read head separately incorporated in different head chips, can be completed in the above-described steps.

Next, a process for producing a portion adjacent to the read head will be described.

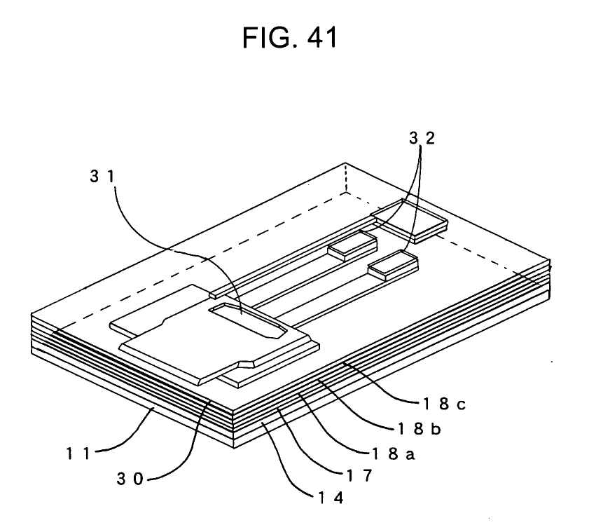

As shown in FIG. 41, a via hole 31 for connecting the intermediate magnetic shield layer 28 with an upper magnetic core 35 and a via hole 32 for connecting the external terminals 36 with an external circuit is formed in the fourth gap film 30 by photolithography and ion etching.

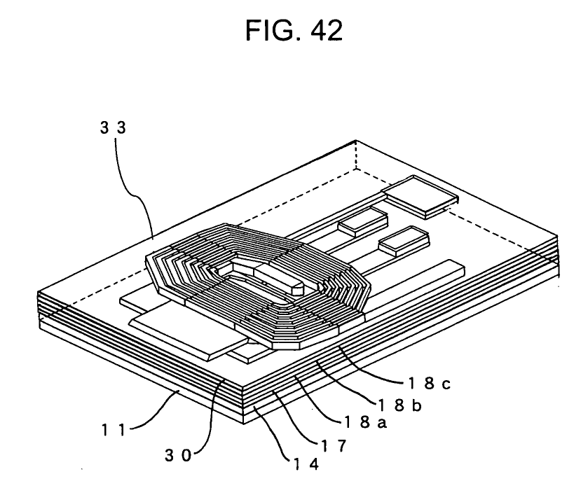

As shown in FIG. 42, a first coil 33 composed of a conductive material is formed on the fourth gap film 30 by plating or the like.

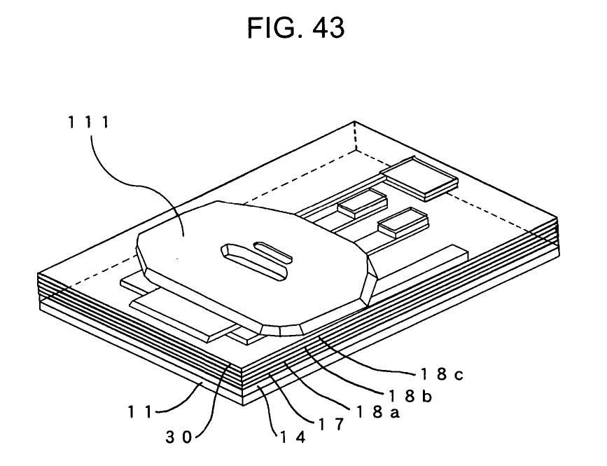

Then, as shown in FIG. 43, a photoresist pattern 111 for insulating the first coil 33 from a second coil 34 described below is formed over the first coil 33.

This photoresist pattern 111 is heat-treated into an electrical insulating layer.

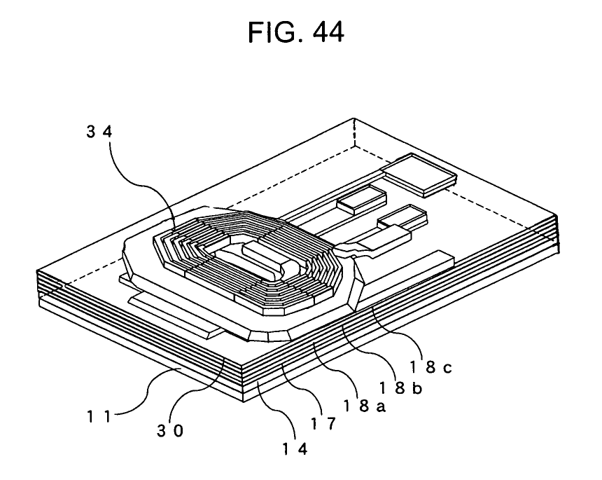

As shown in FIG. 44, the second coil 34 composed of a conductive material is formed on the photoresist pattern 111 by plating or the like.

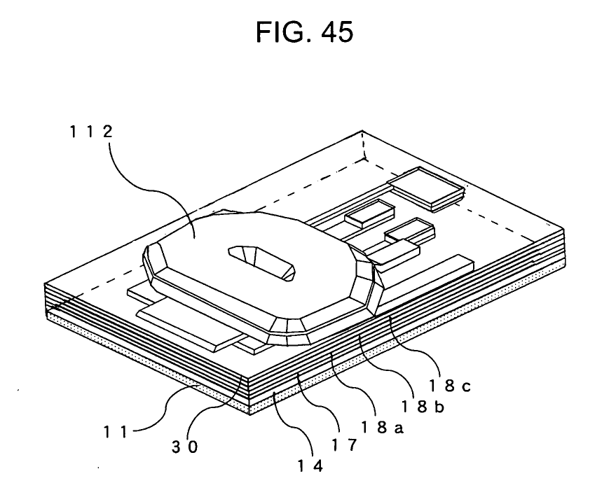

Then, as shown in FIG. 45, a photoresist pattern 112 for insulating the second coil 34 from the upper magnetic core 35 is formed over the second coil 34.

This photoresist pattern 112 is heat-treated into an electrical insulating layer.

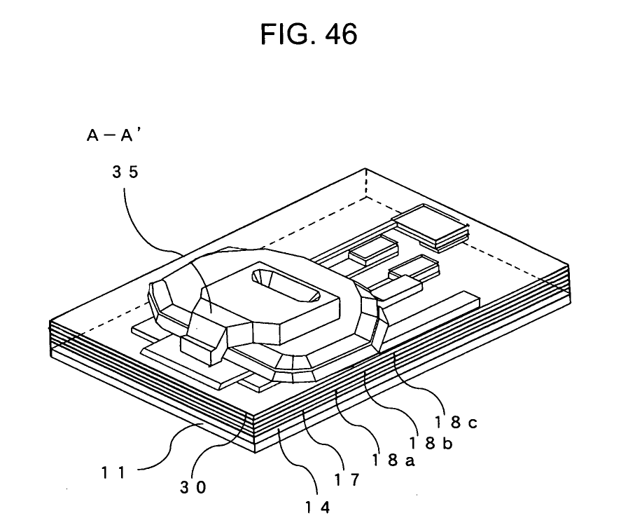

As shown in FIG. 46, A soft magnetic thin film composed of an amorphous Ni—Fe-based alloy, an amorphous ZrNbTa alloy, a Fe—Si—Al-based alloy, or the like and having a thickness of, for example, about 3 μm is formed on the heat-treated photoresist pattern 112 by sputtering, plating, or the like. Then, the resulting soft magnetic thin film is processed into a predetermined shape by photolithography and ion etching to form the upper magnetic core 35 on the photoresist pattern 112.

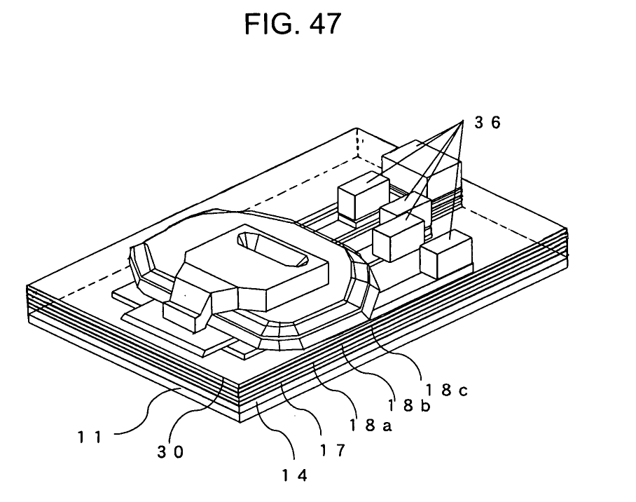

As shown in FIG. 47, the external terminals 36 each composed of a conductive material are formed on the electrodes 26 connected to the MR element, the grounding electrode 29, and the coil electrode by plating or the like.

An example of an integrated head including both a read head and a write head is produced by the above-described production process.

In general, a read head in a linear-scan magnetic read/write system, which includes a plurality of integrated heads each having a write head and a read head, the write head being adjacent to a read head, and the plurality of integrated heads being provided on the same head chip or head block and being adjacent to each other, can be completed by the above-described steps.

The substrate provided with many heads is separated into rectangular substrate pieces by a known method in a manner such that the heads are aligned in the transverse direction.

Each of the resulting rectangular substrates is bonded with another substrate.

Bonding of the substrate is performed with, for example, a resin adhesive. Then, similarly, yet another substrate is bonded with the resin adhesive.

Subsequently, the MR element is cut to separate the heads.

Then, barrel polishing is performed, and a head chip is fabricated to complete an MR head.

According to the above-described process, a flux guide MR head and a head block for a helical-scan magnetic read/write system or a flux guide MR head and a head chip for a linear-scan magnetic read/write system in accordance with an embodiment of the present invention can be produced.

However, the above-described process is only an example. A process for producing a flux guide MR head according to an embodiment of the present invention is not limited to the above-described process.

Furthermore, a magnetic head according to an embodiment of the present invention does not depend on applications and the shape, i.e., the magnetic head does not depend on whether the magnetic head is suitable for a helical-scan magnetic read/write system or a linear-scan magnetic read/write system.

In the present invention, an MR head according to an embodiment of the present invention advantageously has a function of efficiently removing static charges therein, thereby eliminating the need for imparting this function of removing static charges to a magnetic recording medium. As a result, a typical deterioration in read/write characteristics due to a static charge-removing path provided in the magnetic recording medium can be prevented. Consequently, the integrated system of a magnetic recording medium and the head can be advantageously provided while achieving a good balance between improved read/write characteristics and high reliability because of no destruction of the head due to static electricity.

Therefore, the present invention is not limited to processes for producing a head, a head chip, and a head block, and applications.

### EXAMPLES

Samples according to embodiments of the present invention were made, and the characteristics of the samples were evaluated.

Magnetic recording medium used for experiments were produced by the following process.

A dispersion for forming a magnetic layer was prepared according to the following composition.

[Composition of Dispersion for Forming Magnetic Layer]

Ferromagnetic fine powder (Fe—Co-based alloy): 100 parts by weight
Binder: polyester polyurethane resin: 8 parts by weight (weight-average molecular weight: 41,200)
Binder: vinyl chloride copolymer (average degree of polymerization: 350): 10 parts by weight
Inorganic powder (abrasive): α-Al₂O₃: 5 parts by weight (particle size: 200 nm, BET specific surface area: 11.1 m²/g)
Lubricant: stearic acid: 1 part by weight
   : butyl stearate: 2 parts by weight
Solvent: methyl ethyl ketone: 20 parts by weight
   : toluene: 20 parts by weight
   : cyclohexanone: 10 parts by weight

The above-described materials were kneaded with a kneader. The resulting mixture was further diluted with methyl ethyl ketone, toluene, and cyclohexanone and then dispersed by a sand mill. The resulting dispersion was separated into three dispersion fractions.

A first dispersion fraction was further dispersed by a sand mill. The resulting dispersion was defined as dispersion A.

To a second dispersion fraction, 0.5 part by weight of carbon black was added. The resulting mixture was dispersed by a sand mill. The resulting dispersion was defined as dispersion B.

To a third dispersion fraction, 10 parts by weight of carbon black was added. The resulting mixture was dispersed by a sand mill. The resulting dispersion was defined as dispersion C.

Next, a nonmagnetic dispersion for forming a nonmagnetic layer was prepared according to the following composition.

[Composition I for Dispersion for Nonmagnetic Layer]

Nonmagnetic powder: α-iron oxide (hematite): 100 parts by weight
Binder: polyester polyurethane resin: 8 parts by weight (weight-average molecular weight: 41,200)
Binder: vinyl chloride copolymer (average degree of polymerization: 350): 10 parts by weight
Inorganic powder (abrasive): α-Al₂O₃: 5 parts by weight (particle size: 200 nm, BET specific surface area: 11.1 m²/g)
Lubricant: stearic acid: 1 part by weight
   : butyl stearate: 2 parts by weight
Solvent: methyl ethyl ketone: 20 parts by weight
   : toluene: 20 parts by weight
   : cyclohexanone: 10 parts by weight

The above-described materials were kneaded with a kneader. The resulting mixture was further diluted with methyl ethyl ketone, toluene, and cyclohexanone and then dispersed by a sand mill. The resulting dispersion was separated into three dispersion fractions.

A first dispersion fraction was further dispersed by a sand mill. The resulting dispersion was defined as dispersion D.

To a second dispersion fraction, 0.5 part by weight of carbon black was added. The resulting mixture was dispersed by a sand mill. The resulting dispersion was defined as dispersion E.

To a third dispersion fraction, 20 parts by weight of carbon black was added. The resulting mixture was dispersed by a sand mill. The resulting dispersion was defined as dispersion F.

To each of the dispersions D, E, and F, 4 parts by weight of a polyisocyanate (curing agent: COLLONATE L, manufactured by Nippon Polyurethane Industry Co., Ltd.) was added. The resulting mixtures were stirred.

A nonmagnetic dispersion for forming a nonmagnetic layer was prepared according to the following composition.

[Composition II for Dispersion for Nonmagnetic Layer]

Nonmagnetic powder: carbon-coated α-iron oxide: 100 parts by weight
Binder: polyester polyurethane resin: 8 parts by weight (weight-average molecular weight: 41,200)
Binder: vinyl chloride copolymer (average degree of polymerization: 350): 10 parts by weight
Inorganic powder (abrasive): α-Al₂O₃: 5 parts by weight (particle size: 200 nm, BET specific surface area: 11.1 m²/g)
Lubricant: stearic acid: 1 part by weight
   : butyl stearate: 2 parts by weight
Solvent: methyl ethyl ketone: 20 parts by weight
   : toluene: 20 parts by weight
   : cyclohexanone: 10 parts by weight

The above-described materials were kneaded with a kneader. The resulting mixture was further diluted with methyl ethyl ketone, toluene, and cyclohexanone and then dispersed by a sand mill. The resulting dispersion was separated into two dispersion fractions.

A first dispersion fraction was further dispersed by a sand mill. The resulting dispersion was defined as dispersion G.

To a second dispersion fraction, 99 percent by weight of the dispersion A was added relative to 1 percent by weight of the second dispersion fraction. The resulting mixture was dispersed by a sand mill. The resulting dispersion was defined as dispersion H.

To each of the dispersions G and H, 4 parts by weight of a polyisocyanate (curing agent: COLLONATE L, manufactured by Nippon Polyurethane Industry Co., Ltd.) was added. The resulting mixtures were stirred.

Each of the dispersions D, E, F, G, and H was applied on a nonmagnetic support to form a nonmagnetic layer having a thickness of 1 μm. Then, one of the dispersions A, B, and C was applied on each of the resulting undried nonmagnetic layer to form a magnetic layer in a manner such that the resulting magnetic layer had a predetermined thickness shown in Table 1.

The resulting support having the layers was subjected to magnetic field orientation and drying. The resulting support was wounded and then subjected to calendering.

Next, the resulting support having the layers was subjected to curing.

To a dispersion for forming a back-coat layer, 10 parts by weight of polyisocyanate (curing agent: COLLONATE L, manufactured by Nippon Polyurethane Industry Co., Ltd.) was added. The resulting dispersion was applied to the surface not including the magnetic layer to form a back-coat layer having a thickness of 0.5 μm.

[Composition of Dispersion for Forming Back-Coat Layer]

Inorganic powder: carbon black: 100 parts by weight (particle size: 40 nm, amount of DBP oil absorbed: 112.0 ml/100 g)
Binder: polyester polyurethane resin: 13 parts by weight (weight-average molecular weight: 71,200)
Binder: phenoxy resin (average degree of polymerization: 100): 43 parts by weight
Binder: nitrocellulose resin (average degree of polymerization: 90): 10 parts by weight
Solvent: methyl ethyl ketone: 500 parts by weight
   : toluene: 500 parts by weight

As described above, the dispersions A to C for forming magnetic layers and the dispersions D to H for forming nonmagnetic layers were appropriately combined to form media 1 to 28 while controlling the thickness of the magnetic layers. Each of the resulting media was slit into sample tapes each having a width of 12 mm.

With respect to sample heads, a head chip and a head block each including a flux guide MR head were produced according to the above-described process.

That is, a head block including a flux guide MR head used for a helical-scan magnetic read/write system and a head chip including a flux guide MR head used for a linear-scan read/write system were prepared.

For comparison purposes, a head block including a head having a known structure and a head chip including a known structure were prepared, the flux guide MR heads not having static charge-removing paths 12 and 29 as shown in FIG. 2.

Magnetic read/write systems incorporating the sample tapes in combination with the sample heads were evaluated for the surface roughness of the magnetic layer, the surface electric resistivity of the magnetic layer, the magnetostatic properties of the magnetic recording medium, the C/N characteristics of the magnetic read/write system, and the stability of the magnetic read/write system after operation.

Evaluation methods will be described below.

[Measurement of Surface Roughness]

The surface roughness in the range of 50×50 μm² was measured with a measuring machine (trade name: Nano Scope IIIa/D-3000 manufactured by Digital Instruments).

The roughness average Ra was used as an index of the surface roughness. Table 1 shows the parameters.

[Measurement of Surface Electric Resistivity]

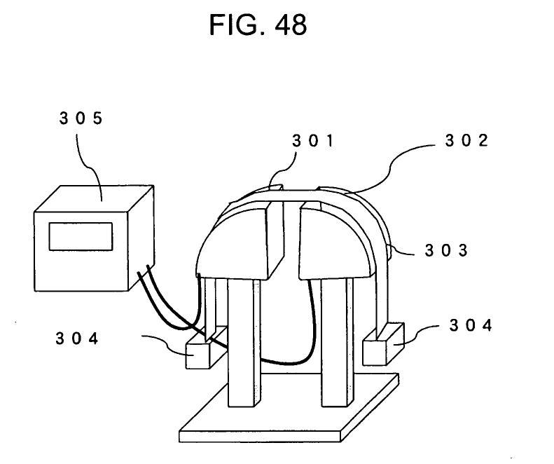

The surface electric resistivity was measured with an evaluating device as shown in FIG. 48.

An evaluation sample of a magnetic recording medium 303 was disposed on ¼-arc-shaped metal electrodes 301 and 302, the metal electrodes 301 and 302 facing each other, in a manner such that the magnetic layer side of the magnetic recording medium 303 was in contact with the metal electrodes 301 and 302. Weights 304 each having a weight of 150 gf were attached to the ends of the evaluation sample.

The distance between the metal electrodes facing each other was set to ½ inch.

To bring the magnetic recording medium across the width direction into satisfactory contact with the metal electrodes, the width of the surface, which is brought into contact with the magnetic recording medium, of each of the metal electrodes 301 and 302 was greater than the width of the magnetic recording medium.

DC voltages from ten to several hundreds volts were applied between the electrodes with a voltage supplier 305 (also serving as a resistance measuring unit). A current flowing through the magnetic recording medium was measured, and then electrical resistance was calculated.

A predetermined calculation was performed using the resulting electrical resistance (unit: Ω) to determine surface electric resistivity (unit: Ω/sq). Table 1 shows the results.

[Magnetostatic Properties]

The magnetostatic properties of the magnetic recording medium were measured with a vibrating sample type magnetometer (VSM).

In the evaluation of the magnetostatic properties of the magnetic recording medium according to an embodiment of the present invention, a squareness ratio (Rs), which was a physical quantity measured with the VSM, was used and shown in Table 1.

In an M-H hysteresis curve, i.e., in a major loop, the ratio of a residual magnetization Mr at the boundary (H=0) between the first quadrant and the second quadrant of the major loop to the maximum value Ms of M, i.e., Mr/Ms, was defined as the squareness ratio (Rs). The squareness ratio represented in terms of percentage (%) was shown in Table 1.

TABLE 1

| | Dispersion | Dispersion for | Thickness | | Surface | Surface |
|---|---|---|---|---|---|---|
| | for magnetic | nonmagnetic | of magnetic | Remanence | roughness | resistivity |
| | layer | layer | layer (μm) | ratio (%) | Ra (nm) | (Ω/sq) |
| Medium 1 | Dispersion A | Dispersion D | 0.4 | 90.5 | 3.3 | 9.7 × 10¹² |
| Medium 2 | Dispersion A | Dispersion D | 0.3 | 90.2 | 3.5 | 1.0 × 10¹³ |
| Medium 3 | Dispersion A | Dispersion D | 0.1 | 90.3 | 3.7 | 8.9 × 10¹² |
| Medium 4 | Dispersion A | Dispersion D | 0.05 | 91.3 | 3.8 | 9.9 × 10¹² |
| Medium 5 | Dispersion A | Dispersion E | 0.3 | 90.0 | 3.7 | 5.9 × 10¹⁰ |
| Medium 6 | Dispersion A | Dispersion E | 0.1 | 90.1 | 3.7 | 1.5 × 10¹⁰ |
| Medium 7 | Dispersion A | Dispersion E | 0.05 | 89.9 | 3.8 | 7.8 × 10⁹ |
| Medium 8 | Dispersion A | Dispersion F | 0.3 | 90.2 | 4.4 | 7.7 × 10⁶ |
| Medium 9 | Dispersion A | Dispersion F | 0.1 | 90.0 | 4.5 | 6.8 × 10⁶ |
| Medium 10 | Dispersion A | Dispersion F | 0.05 | 91.0 | 4.8 | 3.0 × 10⁶ |
| Medium 11 | Dispersion B | Dispersion D | 0.3 | 87.9 | 3.5 | 1.5 × 10¹¹ |
| Medium 12 | Dispersion B | Dispersion D | 0.1 | 88.4 | 3.6 | 3.0 × 10¹¹ |
| Medium 13 | Dispersion B | Dispersion D | 0.05 | 88.2 | 3.7 | 5.4 × 10¹¹ |
| Medium 14 | Dispersion B | Dispersion E | 0.3 | 88.2 | 3.7 | 7.4 × 10⁸ |
| Medium 15 | Dispersion B | Dispersion E | 0.1 | 88.3 | 3.8 | 3.6 × 10⁸ |
| Medium 16 | Dispersion B | Dispersion E | 0.05 | 89.2 | 3.8 | 1.2 × 10⁸ |
| Medium 17 | Dispersion C | Dispersion D | 0.3 | 82.0 | 3.7 | 1.8 × 10⁶ |
| Medium 18 | Dispersion C | Dispersion D | 0.1 | 81.0 | 3.8 | 2.4 × 10⁷ |
| Medium 19 | Dispersion C | Dispersion D | 0.05 | 82.0 | 3.8 | 9.4 × 10⁷ |
| Medium 20 | Dispersion C | Dispersion F | 0.3 | 82.2 | 4.7 | 1.3 × 10⁶ |
| Medium 21 | Dispersion C | Dispersion F | 0.1 | 80.3 | 4.7 | 2.1 × 10⁶ |
| Medium 22 | Dispersion C | Dispersion F | 0.05 | 81.3 | 4.8 | 1.2 × 10⁶ |
| Medium 23 | Dispersion A | Dispersion G | 0.3 | 90.3 | 4.3 | 1.4 × 10⁷ |
| Medium 24 | Dispersion A | Dispersion G | 0.1 | 90.1 | 4.3 | 1.2 × 10⁷ |
| Medium 25 | Dispersion A | Dispersion G | 0.05 | 91.1 | 4.5 | 8.3 × 10⁶ |
| Medium 26 | Dispersion A | Dispersion H | 0.3 | 90.3 | 3.7 | 4.3 × 10¹⁰ |
| Medium 27 | Dispersion A | Dispersion H | 0.1 | 90.1 | 3.8 | 8.8 × 10⁹ |
| Medium 28 | Dispersion A | Dispersion H | 0.05 | 90.8 | 3.8 | 5.4 × 10⁹ |

[Electromagnetic Conversion Characteristics]

The electromagnetic conversion characteristics of the tape samples were measured with evaluation apparatuses suitable for the shapes of the two heads prepared.

With respect to a head chip including a read head without a write head, in other words, with respect to a read head used for a helical-scan magnetic read/write system, the electromagnetic conversion characteristics were measured with a helical-scan magnetic read/write apparatus including a rotary drum provided with a write head (MIG, gap: 0.15 μm) in addition to the head chip.

On the other hand, with respect to a head block including a plurality of read heads and a plurality of write heads adjacent to the plurality of read heads, in other words, with respect to a read head used for a linear-scan magnetic read/write system, the electromagnetic conversion characteristics were measured with a linear-scan magnetic read/write apparatus including the head block.

In this case, writing was performed with the write heads included in the head block, and reading was performed with the read heads included in the head block.

In the evaluations of the heads used for the helical-scan magnetic read/write system and the linear-scan magnetic read/write system, after writing a signal having a wavelength of 0.25 μm, a readout output and a noise were measured with spectrum analyzer.

The strength of the frequency components within a range of plus/minus 2 MHz from the frequency the readout signal was defined as a noise level. The ratio of the readout signal output to the noise out put was defined as C/N characteristics.

Tables 2 and 3 showed the results on the heads used for the helical-scan magnetic read/write systems. Tables 4 and 5 showed the results on the heads used for the linear-scan magnetic read/write systems.

The C/N value measured in Comparative example 1 is defined as a reference value 0.0 dB. The C/N values measured in Comparative examples and Examples were shown as relative values in Tables 2 to 5.

[Stability of Magnetic Read/Write System After Operation]

In each evaluation system in the above-described method for evaluating the electromagnetic conversion characteristics, a shuttle test (about 100 passes) was performed. Next, the magnetic recording medium was removed from the magnetic read/write system, and cleaning or the like was performed.

Then, the magnetic recording medium was attached to the magnetic read/write system again, and the shuttle test (about 100 passes) was performed.

After this operation was repeated several hundred times, the above-described electromagnetic conversion characteristics were evaluated.

In Comparative examples and Examples, with respect to each magnetic read/write system incorporating the magnetic recording medium in combination with the read head shown in Tables, when the read head had no failure and could be evaluated again, the system was regarded as stable. In this case, the system stability was described as P (pass). Otherwise the system stability was described as F (failure).

TABLE 2

| | Evaluated | Static charge- | C/N [dB] | System |
|---|---|---|---|---|
| | medium | removing path | (Relative value) | stability |
| Example 1 | Medium 2 | Presence | 2.1 | P |
| Example 2 | Medium 3 | Presence | 2.2 | P |
| Example 3 | Medium 4 | Presence | 2.2 | P |
| Example 4 | Medium 14 | Presence | 1.7 | P |
| Example 5 | Medium 15 | Presence | 1.7 | P |
| Example 6 | Medium 16 | Presence | 1.7 | P |
| Example 7 | Medium 5 | Presence | 1.7 | P |
| Example 8 | Medium 6 | Presence | 1.9 | P |
| Example 9 | Medium 7 | Presence | 1.9 | P |
| Example 10 | Medium 11 | Presence | 1.5 | P |
| Example 11 | Medium 12 | Presence | 1.6 | P |
| Example 12 | Medium 13 | Presence | 1.8 | P |
| Example 13 | Medium 26 | Presence | 1.8 | P |
| Example 14 | Medium 27 | Presence | 1.9 | P |
| Example 15 | Medium 28 | Presence | 1.8 | P |

TABLE 3

| | Evaluated | Static charge- | C/N [dB] | System |
|---|---|---|---|---|
| | medium | removing path | (Relative value) | stability |
| Comparative | Medium 20 | Absence | 0 | P |
| example 1 | | | | |
| Comparative | Medium 21 | Absence | 0.2 | P |
| example 2 | | | | |
| Comparative | Medium 22 | Absence | −0.1 | P |
| example 3 | | | | |
| Comparative | Medium 20 | Presence | 0.1 | P |
| example 4 | | | | |
| Comparative | Medium 21 | Presence | 0.3 | P |
| example 5 | | | | |
| Comparative | Medium 22 | Presence | 0.1 | P |
| example 6 | | | | |
| Comparative | Medium 17 | Absence | 0.5 | P |
| example 7 | | | | |
| Comparative | Medium 18 | Absence | 0.8 | P |
| example 8 | | | | |
| Comparative | Medium 19 | Absence | 0.6 | P |
| example 9 | | | | |
| Comparative | Medium 17 | Presence | 0.4 | P |
| example 10 | | | | |
| Comparative | Medium 18 | Presence | 0.6 | P |
| example 11 | | | | |
| Comparative | Medium 19 | Presence | 0.6 | P |
| example 12 | | | | |
| Comparative | Medium 11 | Absence | 1.4 | F |
| example 13 | | | | |
| Comparative | Medium 12 | Absence | 1.6 | F |
| example 14 | | | | |
| Comparative | Medium 13 | Absence | 1.6 | F |
| example 15 | | | | |
| Comparative | Medium 14 | Absence | 1.7 | F |
| example 16 | | | | |
| Comparative | Medium 15 | Absence | 1.6 | F |
| example 17 | | | | |
| Comparative | Medium 16 | Absence | 1.7 | F |
| example 18 | | | | |
| Comparative | Medium 8 | Absence | 0.6 | P |
| example 19 | | | | |
| Comparative | Medium 9 | Absence | 0.7 | P |
| example 20 | | | | |
| Comparative | Medium 10 | Absence | 0.5 | P |
| example 21 | | | | |
| Comparative | Medium 8 | Presence | 0.5 | P |
| example 22 | | | | |
| Comparative | Medium 9 | Presence | 0.8 | P |
| example 23 | | | | |
| Comparative | Medium 10 | Presence | 0.7 | P |
| example 24 | | | | |
| Comparative | Medium 5 | Absence | 1.8 | F |
| example 25 | | | | |
| Comparative | Medium 6 | Absence | 1.9 | F |
| example 26 | | | | |
| Comparative | Medium 7 | Absence | 2.0 | F |
| example 27 | | | | |
| Comparative | Medium 2 | Absence | 1.9 | F |
| example 28 | | | | |
| Comparative | Medium 3 | Absence | 2.3 | F |
| example 29 | | | | |
| Comparative | Medium 4 | Absence | 2.1 | F |
| example 30 | | | | |
| Comparative | Medium 26 | Absence | 1.9 | F |
| example 31 | | | | |
| Comparative | Medium 27 | Absence | 1.9 | F |
| example 32 | | | | |
| Comparative | Medium 28 | Absence | 1.9 | F |
| example 33 | | | | |
| Comparative | Medium 23 | Absence | 0.7 | P |
| example 34 | | | | |
| Comparative | Medium 24 | Absence | 0.8 | P |
| example 35 | | | | |
| Comparative | Medium 25 | Absence | 0.8 | P |
| example 36 | | | | |
| Comparative | Medium 23 | Presence | 0.8 | P |
| example 37 | | | | |
| Comparative | Medium 24 | Presence | 0.9 | P |
| example 38 | | | | |
| Comparative | Medium 25 | Presence | 0.9 | P |
| example 39 | | | | |
| Comparative | Medium 1 | Absence | −0.5 | F |
| example 40 | | | | |
| Comparative | Medium 1 | Presence | −0.7 | P |
| example 41 | | | | |

TABLE 4

| | Evaluated | Static charge- | C/N [dB] | System |
|---|---|---|---|---|
| | medium | removing path | (Relative value) | stability |
| Example 1 | Medium 2 | Presence | 2.2 | P |
| Example 2 | Medium 3 | Presence | 2.4 | P |
| Example 3 | Medium 4 | Presence | 2.4 | P |
| Example 4 | Medium 14 | Presence | 1.8 | P |
| Example 5 | Medium 15 | Presence | 1.8 | P |
| Example 6 | Medium 16 | Presence | 1.7 | P |
| Example 7 | Medium 5 | Presence | 2.1 | P |
| Example 8 | Medium 6 | Presence | 2.2 | P |
| Example 9 | Medium 7 | Presence | 2.1 | P |
| Example 10 | Medium 11 | Presence | 1.8 | P |
| Example 11 | Medium 12 | Presence | 1.8 | P |
| Example 12 | Medium 13 | Presence | 1.9 | P |
| Example 13 | Medium 26 | Presence | 2.0 | F |
| Example 14 | Medium 27 | Presence | 2.2 | F |
| Example 15 | Medium 28 | Presence | 2.3 | F |

TABLE 5

| | | Static | C/N | |
|---|---|---|---|---|
| | | charge- | [dB] | |
| | Evaluated | removing | (Relative | System |
| | medium | path | value) | stability |
| Comparative example 1 | Medium 20 | Absence | 0 | P |
| Comparative example 2 | Medium 21 | Absence | 0 | P |
| Comparative example 3 | Medium 22 | Absence | 0 | P |
| Comparative example 4 | Medium 20 | Presence | 0 | P |
| Comparative example 5 | Medium 21 | Presence | −0.1 | P |
| Comparative example 6 | Medium 22 | Presence | 0 | P |
| Comparative example 7 | Medium 17 | Absence | 0.5 | P |
| Comparative example 8 | Medium 18 | Absence | 0.7 | P |
| Comparative example 9 | Medium 19 | Absence | 0.7 | P |
| Comparative example 10 | Medium 17 | Presence | 0.5 | P |
| Comparative example 11 | Medium 18 | Presence | 0.6 | P |
| Comparative example 12 | Medium 19 | Presence | 0.6 | P |
| Comparative example 13 | Medium 11 | Absence | 1.7 | F |
| Comparative example 14 | Medium 12 | Absence | 1.8 | F |
| Comparative example 15 | Medium 13 | Absence | 1.7 | F |
| Comparative example 16 | Medium 14 | Absence | 1.6 | F |
| Comparative example 17 | Medium 15 | Absence | 1.6 | F |
| Comparative example 18 | Medium 16 | Absence | 1.7 | F |
| Comparative example 19 | Medium 8 | Absence | 0.5 | P |
| Comparative example 20 | Medium 9 | Absence | 0.5 | P |
| Comparative example 21 | Medium 10 | Absence | 0.5 | P |
| Comparative example 22 | Medium 8 | Presence | 0.6 | P |
| Comparative example 23 | Medium 9 | Presence | 0.6 | P |
| Comparative example 24 | Medium 10 | Presence | 0.6 | P |
| Comparative example 25 | Medium 5 | Absence | 2.0 | F |
| Comparative example 26 | Medium 6 | Absence | 2.2 | F |
| Comparative example 27 | Medium 7 | Absence | 2.2 | F |
| Comparative example 28 | Medium 2 | Absence | 2.3 | F |
| Comparative example 29 | Medium 3 | Absence | 2.5 | F |
| Comparative example 30 | Medium 4 | Absence | 2.4 | F |
| Comparative example 31 | Medium 26 | Absence | 2.1 | F |
| Comparative example 32 | Medium 27 | Absence | 2.1 | F |
| Comparative example 33 | Medium 28 | Absence | 2.2 | F |
| Comparative example 34 | Medium 23 | Absence | 0.5 | P |
| Comparative example 35 | Medium 24 | Absence | 0.6 | P |
| Comparative example 36 | Medium 25 | Absence | 0.7 | P |
| Comparative example 37 | Medium 23 | Presence | 0.4 | P |
| Comparative example 38 | Medium 24 | Presence | 0.5 | P |
| Comparative example 39 | Medium 25 | Presence | 0.7 | P |
| Comparative example 40 | Medium 1 | Absence | −0.6 | F |
| Comparative example 41 | Medium 1 | Presence | −0.5 | P |

Tables 2 and 3 showed the C/N characteristics and the system stability in the combinations of media 1 to 28 described in Table 1 and either the read heads, not including a static charge-removing path, used for the helical-scan magnetic read/write system or the read head, including a static charge-removing path, used for the helical-scan magnetic read/write system.

Tables 4 and 5 showed the C/N characteristics and the system stability in the combinations of media 1 to 28 described in Table 1 and either the read heads, not including a static charge-removing path, used for the linear-scan magnetic read/write system or the read head, including a static charge-removing path, used for the linear-scan magnetic read/write system.

As shown in Tables 2 and 4, in Examples 1 to 15, in which the read head, including a static charge-removing path, used for the helical-scan magnetic read/write system or the read head, including a static charge-removing path, used for the linear-scan magnetic read/write system, satisfactory C/N characteristics and excellent system stability were obtained.

Media 2 to 7, 11 to 14, and 26 to 28 used in Example 1 to 15 had different structures. However, the surface electric resistivity of the magnetic layer of each of the media is in the range of 1×10⁸ to 1×10¹³ Ω/sq.

Traditionally, in order to reduce the surface electric resistivity of the magnetic recording medium, the following process has been employed: a process of not adding any conductive material; a process of incorporating a very small amount of a conductive material into a medium; or a process of incorporating a conductive material in a special form, such as conductive material-coated magnetic particles. However, in an embodiment of the present invention, there is no need for such a process. That is, it was clear that a magnetic read/write system including a read head having a static charge-removing path could achieve a good balance between satisfactory electromagnetic conversion characteristics and excellent system stability.

The magnetic layers in media 2 to 7, 11 to 16, and 26 to 28 used in Example 1 to 15 were different. However, by applying the magnetic read/write systems having the satisfactory characteristics of the read heads according to an embodiment of the present invention, excellent evaluation results were obtained.

On the other hand, as shown in Tables 3 and 5, in Comparative examples 1 to 3, 7 to 9, 19 to 21, and 34 to 36, the magnetic read/write system including the read head, not having a static charge-removing path, used for magnetic read/write system was applied. Satisfactory evaluation results on the system stability were obtained because of very low surface electric resistance of the magnetic layer in each magnetic recording medium. However, since each of the magnetic recording media served as a static charge-removing path, the C/N characteristics were degraded.

In Comparative examples 4 to 6, 10 to 12, 22 to 24, and 37 to 39, the magnetic read/write system including the read head, having a static charge-removing path, used for magnetic read/write system was applied, and the surface electric resistance of the magnetic layer in each magnetic recording medium was very low. Thus, satisfactory evaluation results on the system stability were obtained. However, the C/N characteristics were unsatisfactory in practical applications.

On the other hand, in Comparative examples 13 to 18 and 25 to 33, the magnetic read/write system including the read head, not having a static charge-removing path, used for magnetic read/write system was applied. For the magnetic recording medium, the magnetic layer in each magnetic recording medium having a surface electric resistance of 1×10⁸ to 1×10¹³ Ω/sq was provided. As a result, static charges (static electricity) on the magnetic head could not be effectively removed, thereby degrading system stability.

In Comparative examples 40 and 41, a highly sensitive read head was used as described above. Since the thick magnetic layer had a thickness of 0.4 μm, the noise level was increased, thus degrading the C/N characteristics.

In Comparative example 40, the read/write system including the read head, not having a static charge-removing path, used for the magnetic read/write system was applied. The static charges (static electricity) on the magnetic head could not be effectively removed, thereby degrading system stability.

As is clear from the above description, with respect to a read/write system including a magnetoresistive head in combination with a magnetic recording medium, in order to prevent the electrostatic destruction of the magnetoresistive head, a static charge-removing path for removing accumulated charges (static electricity) was provided in the magnetoresistive head. As a result, static charges were removed, and thus electrostatic destruction was prevented. Furthermore, it was possible to specially modify the structure of the magnetic recording medium such that the electromagnetic conversion characteristics were improved.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic read/write system comprising:
a magnetic read/write apparatus including a magnetoresistive head having at least one flux guide; and
a magnetic recording medium including a magnetic layer on a nonmagnetic support;
wherein the magnetoresistive head includes static charge-removing means for removing static charges,
the thickness of the magnetic layer constituting the magnetic recording medium is 0.3 μm or less, and
the surface electric resistivity of the surface of the magnetic layer is in the range of 1×10⁸ to 1×10¹³ Ω/sq.

2. A magnetic medium applied to a magnetic read/write apparatus including a magnetoresistive head having at least one flux guide, the magnetic medium comprising:
a magnetic layer on a nonmagnetic support, wherein the magnetoresistive head includes static charge-removing means for removing static charges,
the thickness of the magnetic layer is 0.3 μm or less, and the surface electric resistivity of the surface of the magnetic layer is in the range of 1×10⁸ to 1×10¹³ Ω/sq.

3. A magnetic read/write system comprising:
a magnetic read/write apparatus including a magnetoresistive head having at least one flux guide; and
a magnetic recording medium including a magnetic layer on a nonmagnetic support;
wherein the flux guide or a thin-film structure physically or electrically connected to the flux guide has a static charge-removing function of removing static charges in the magnetoresistive head,
the thickness of the magnetic layer is 0.3 μm or less, and the surface electric resistivity of the surface of the magnetic layer is in the range of 1×10⁸ to 1×10¹³ Ω/sq.

4. A magnetic medium applied to a magnetic read/write apparatus including a magnetoresistive head having at least one flux guide, the magnetic medium comprising:
a magnetic layer on a nonmagnetic support,
wherein the flux guide or a thin-film structure physically or electrically connected to the flux guide has a static charge-removing function of removing static charges in the magnetoresistive head,
the thickness of the magnetic layer is 0.3 μm or less, and the surface electric resistivity of the surface of the magnetic layer is in the range of 1×10⁸ to 1×10¹³ Ω/sq.

5. A magnetoresistive head comprising:
at least one flux guide,
wherein the flux guide or a thin-film structure physically or electrically connected to the flux guide has a function of removing static charges in the magnetoresistive head.

6. A magnetic read/write system comprising:
a magnetic read/write apparatus including a magnetoresistive head having at least one flux guide; and
a magnetic recording medium including a magnetic layer on a nonmagnetic support;
wherein the flux guide or a thin-film structure physically or electrically connected to the flux guide is connected to an electrode or a conductor, the electrode or the conductor having a function of removing static charges in the magnetoresistive head,
the thickness of the magnetic layer is 0.3 μm or less, and the surface electric resistivity of the surface of the magnetic layer is in the range of 1×10⁸ to 1×10¹³ Ω/sq.

7. A magnetic medium applied to a magnetic read/write apparatus including a magnetoresistive head having at least one flux guide, the magnetic medium comprising:
a magnetic layer on a nonmagnetic support,
wherein the flux guide or a thin-film structure physically or electrically connected to the flux guide is connected to an electrode or a conductor, the electrode or the conductor having a function of removing static charges in the magnetoresistive head,
the thickness of the magnetic layer is 0.3 μm or less, and the surface electric resistivity of the surface of the magnetic layer is in the range of 1×10⁸ to 1×10¹³ Ω/sq.

8. A magnetoresistive head comprising:
at least one flux guide,
wherein the flux guide or a thin-film structure physically or electrically connected to the flux guide is connected to an electrode or a conductor, the electrode or the conductor having a function of removing static charges in the magnetoresistive head.

9. A magnetic read/write system comprising:
a magnetic read/write apparatus including a magnetoresistive head having at least one flux guide; and
a magnetic recording medium including a magnetic layer on a nonmagnetic support;
wherein the magnetoresistive head has a static charge-removing function,
the thickness of the magnetic layer constituting the magnetic recording medium is 0.3 μm or less, and
the surface electric resistivity of the surface of the magnetic layer is in the range of 1×10⁸ to 1×10¹³ Ω/sq.
